(19) United States
(12) Patent Application Publication
(10) Pub. No.: US 2020/0171813 A1
(43) Pub. Date: Jun. 4, 2020

(54) INTERMEDIATE TRANSFER MEMBER

(71) Applicant: LANDA CORPORATION LTD., Rehovot (IL)

(72) Inventors: Helena CHECHIK, Rehovot (IL); Shoham LIVADERU, Moshav Sitriyya (IL); Matan BAR-ON, Hod Hasharon (IL); Vadim ABAEV, Lod (IL)

(21) Appl. No.: 16/629,020

(22) PCT Filed: Jul. 11, 2018
(86) PCT No.: PCT/IB2018/055126

§ 371 Date: Jan. 6, 2020

Related U.S. Application Data
(60) Provisional application No. 62/532,400, filed on Jul. 14, 2017.
(60) Provisional application No. 62/641,296, filed on Mar. 10, 2018.
(60) Provisional application No. 62/679,839, filed on Jun. 3, 2018.

(51) Int. Cl. B41J 2/005; B29C 65/72; B29C 65/78; B29C 65/56; B29C 65/50; B29C 65/82; B29C 65/48; B29C 65/00; B29L 31/00

(52) U.S. Cl. CPC B41J 2/0057; B29C 65/72; B29C 65/7805; B29C 65/562; B29C 65/5021; B29C 65/8215; B29L 2031/767; B29C 65/785; B29C 66/1142; B29C 65/7852; B29C 66/4324; B29C 66/3472; B29L 2031/709; B29C 65/4835

(57) ABSTRACT

A heat-curable tape, a kit, and a method for connecting ends of an elongate belt to form an intermediate transfer members suitable for use with indirect printing systems. The kit includes an elongate belt and the heat-curable tape. The kit can include a crimping pin. The method includes using the heat curable tape to join ends of the elongate belt at a seam. A heater is used, in a printing system, for heat-curing the heat-curable tape onto the free ends of the elongate belt so as to form the intermediate transfer member.

### CROSS REFERENCE TO RELATED APPLICATIONS

This patent application claims priority from U.S. Provisional Application No. 62/532,400, filed on Jul. 14, 2017, from U.S. Provisional Application No. 62/641,296, filed on Mar. 10, 2018, and from U.S. Provisional Application No. 62/679,839, filed on Jun. 3, 2018, all of which are entitled “INTERMEDIATE TRANSFER MEMBER”. U.S. Provisional Application Nos. 62/532,400, 62/641,296, and 62/679,839 are all incorporated by reference as if fully set forth herein.

### FIELD AND BACKGROUND OF THE INVENTION

The present disclosure relates to an intermediate transfer member (ITM) used in a printing system in which liquid ink droplets are deposited at an image forming station onto a movable intermediate transfer member and transferred at an impression station from the intermediate transfer member onto a printing substrate. Specifically, this disclosure pertains to an intermediate transfer member formed as a flexible elongate belt, the ends of which are connected to each other by means of a heat-curable tape to form an endless blanket or belt. The disclosure further pertains to systems and devices for installing the heat-curable tape and the intermediate transfer member in corresponding printing systems.

The intermediate transfer member is formed of an elongate flexible belt, which is threaded through the printing system, and the free ends of the belt are connected to one another to form the endless belt of the intermediate transfer member. The portion or element used to connect the free ends of the belt is referred to herein as a seam element.

### SUMMARY OF THE INVENTION

The invention, in some embodiments, relates to a heat-curable tape for connecting ends of an elongate belt to form an intermediate transfer member suitable for use with indirect printing systems.

The invention, in some embodiments, relates to a kit for installing an intermediate transfer member in a printing system, the kit including an elongate belt and a heat-curable tape.

The invention, in some embodiments, relates to a printing system including an intermediate transfer member formed of an elongate belt and a heat-curable tape.

The invention, in some embodiments, relates to a kit for installing an intermediate transfer member in a printing system, the kit including a heat-curable tape and an adhesive.

The invention, in some embodiments, relates to a method for installing an intermediate transfer member in a printing system, the intermediate transfer member including an elongate belt and a heat-curable tape joining ends of the elongate belt at a seam.

The invention, in some embodiments, relates to a heater for heat-curing a heat-curable tape onto free ends of an elongate belt so as to form an intermediate transfer member of a printing system, to printing systems including such a heater, and to methods of using such a heater.

The invention, in some embodiments, relates to a kit for installing an endless belt in a printing system, the kit including an elongate belt and attachment mechanisms.

As is discussed in greater detail hereinbelow, a heat-curable tape according to the present invention includes a substrate layer and a solid silicone rubber layer disposed on the substrate layer. The heat curable tape is applied onto first and second free ends of a flexible belt guided through a suitable route of a printing system, and is then heated so as to heat-cure the solid silicone rubber to the free ends of the flexible belt, thereby to convert the flexible belt into an endless belt of an intermediate transfer member. Heat may be applied to the heat curable tape by a heater, forming part of the printing system in which the intermediate transfer member is being installed, the heater typically disposed beneath the free ends of the belt during heating of the heat-curable tape.

There is thus provided, in accordance with an embodiment of a first aspect of the invention, a kit for installing an endless belt in a printing system, the kit including:
a flexible belt having first and second free ends configured to be guided along the printing system;
a heat-curable tape, including a substrate layer and a solid silicone rubber layer disposed thereon,

wherein the heat-curable tape is adapted to be applied onto the first and second free ends of the flexible belt, and to be heated so as to heat-cure the solid silicone rubber layer of the tape to the first and second free ends of the flexible belt, so as to form a seam connecting the first and second free ends thereby converting the flexible belt into an endless belt.

In some embodiments of the first aspect of the invention, the flexible belt has a length within a range of 1 to 20 meters.

In some embodiments of the first aspect of the invention, the flexible belt has a length within a range of 5 to 20 meters.

In some embodiments of the first aspect of the invention, the flexible belt has a length within a range of 5 to 15 meters.

In some embodiments of the first aspect of the invention, the flexible belt has a length within a range of 5 to 12 meters.

In some embodiments of the first aspect of the invention, the flexible belt has a length within a range of 7 to 12 meters.

In some embodiments of the first aspect of the invention, the flexible belt has a width within a range of 0.1 to 2.0 meters.

In some embodiments of the first aspect of the invention, the flexible belt has a width within a range of 0.3 to 2.0 meters.

In some embodiments of the first aspect of the invention, the flexible belt has a width within a range of 0.5 to 2.0 meters.

In some embodiments of the first aspect of the invention, the flexible belt has a width within a range of 0.75 to 2.0 meters.

In some embodiments of the first aspect of the invention, the flexible belt has a width within a range of 0.75 to 1.5 meters.

In some embodiments of the first aspect of the invention, the flexible belt has a width within a range of 0.75 to 1.25 meters.

In some embodiments of the first aspect of the invention, the flexible belt has a thickness within a range of 50 to 3000 μm.

In some embodiments of the first aspect of the invention, the flexible belt has a thickness within a range of 100 to 3000 μm.

In some embodiments of the first aspect of the invention, the flexible belt has a thickness within a range of 200 to 3000 μm.

In some embodiments of the first aspect of the invention, the flexible belt has a thickness within a range of 200 to 1500 μm.

In some embodiments of the first aspect of the invention, the flexible belt has a thickness within a range of 300 to 1000 μm.

In some embodiments of the first aspect of the invention, the flexible belt has a thickness within a range of 300 to 800 μm.

In some embodiments of the first aspect of the invention, the flexible belt has a thickness within a range of 300 to 700 μm.

In some embodiments of the first aspect of the invention, the flexible belt has a thickness within a range of 100 to 600 μm.

In some embodiments of the first aspect of the invention, following heat-curing of the solid silicone rubber layer, the tape has a tensile strength of at least 8 MPa.

In some embodiments of the first aspect of the invention, following heat-curing of the solid silicone rubber layer, the tape has a shore A hardness of at least 45.

In some embodiments of the first aspect of the invention, following heat-curing of the solid silicone rubber layer, the tape has a shore A hardness not greater than 80.

In some embodiments of the first aspect of the invention, following heat-curing of the solid silicone rubber layer of the heat curable tape, the following properties are true:

the tape has a tensile strength of at least 8 MPa;

the tape has a shore A hardness of at least 45; and

a strength of the heat curable tape is directly proportional to a heat quantity applied to the solid silicone rubber layer during curing of the tape.

In some embodiments of the first aspect of the invention, following heat-curing of the solid silicone rubber layer, the solid silicone rubber layer has a shore A hardness in the range of 55 to 65.

In some embodiments of the first aspect of the invention, the solid silicone rubber includes a thermosetting polymer.

In some embodiments of the first aspect of the invention, the thermosetting polymer includes a platinum catalyzed addition-curing solid silicone rubber.

In some embodiments of the first aspect of the invention, the solid silicone rubber has a density in the range of 1.1 to 1.2 g/cm\hat{ }3.

In some embodiments of the first aspect of the invention, the solid silicone rubber has a density of 1.15 g/cm\hat{ }3.

In some embodiments of the first aspect of the invention, the solid silicone rubber has a shelf life of at least one month.

In some embodiments of the first aspect of the invention, the solid silicone rubber has a shelf life of at least six months.

In some embodiments of the first aspect of the invention, the solid silicone rubber has a shelf life of at least one year.

In some embodiments of the first aspect of the invention, a pot life of the heat curable tape is equal to a shelf life of the solid silicone rubber.

In some embodiments of the first aspect of the invention, a pot life of the heat curable tape is at least one month.

In some embodiments of the first aspect of the invention, a pot life of the heat curable tape is at least six months.

In some embodiments of the first aspect of the invention, a pot life of the heat curable tape is at least one year.

In some embodiments of the first aspect of the invention, the substrate layer includes a fiberglass layer.

In some embodiments of the first aspect of the invention, the substrate layer further includes a silicone coating layer, connected to the fiberglass layer.

In some embodiments of the first aspect of the invention, the silicone coating layer has a shore A hardness in the range of 75 to 80.

In some embodiments of the first aspect of the invention, the substrate layer has a thickness in the range of 110 μm to 170 μm.

In some embodiments of the first aspect of the invention, the substrate layer has a thickness of 160 μm.

In some embodiments of the first aspect of the invention, the solid silicone rubber layer has a thickness in the range of 20 μm to 120 μm.

In some embodiments of the first aspect of the invention, a ratio between a thickness of the solid silicone rubber layer and a thickness of the substrate layer is in the range of 0.10 to 0.75.

In some embodiments of the first aspect of the invention, the curable tape has a thickness in the range of 180 μm to 270 μm.

In some embodiments of the first aspect of the invention, a ratio between a thickness of the tape and a thickness of the belt is in the range of 0.15 to 11.15.

In some embodiments of the first aspect of the invention, a length of the heat curable tape is greater than a width of the flexible belt.

In some embodiments of the first aspect of the invention, a length of the heat curable tape is in the range of 1200 mm to 1300 mm.

In some embodiments of the first aspect of the invention, a width of the heat curable tape is in the range of 20 mm to 30 mm.

In some embodiments of the first aspect of the invention, a ratio between a width of the tape and a length of the belt is in the range of 0.01 to 0.03.

In some embodiments of the first aspect of the invention, the kit further includes a heater adapted to be disposed beneath the heat curable tape when the heat curable tape is applied to the first and second ends of the flexible belt, and adapted to provide heat sufficient for heat-curing the solid silicone rubber of the heat-curable tape thereby to heat-cure the heat curable tape to form the endless belt.

In some embodiments of the first aspect of the invention, the heater includes a heating surface having a width greater than a width of the heat-cured tape. In some embodiments of the first aspect of the invention, the heater is designed such that a greater heat density is provided at ends of the heating surface than at a center of the heating surface.

In some embodiments of the first aspect of the invention, the heater includes a plurality of heating elements, the heating elements being unevenly distributed across the heating surface, such that a greater heat density is provided at ends of the heating surface than at a center of the heating surface.

In some embodiments of the first aspect of the invention, the plurality of heating elements are printed on ceramic plates.

In some embodiments of the first aspect of the invention, the plurality of heating elements are printed on filaments.

In some embodiments of the first aspect of the invention, the plurality of heating elements are printed on mica strips.

In some embodiments of the first aspect of the invention, the plurality of heating elements are printed on silicon strips.

In some embodiments of the first aspect of the invention, the heater is adapted, during operation thereof, to provide a first operative temperature at the center of the heating surface, and to provide a second operative temperature at the ends of the heating surface.

In some embodiments of the first aspect of the invention, the first operative temperature is in the range of 140 C to 180 C.

In some embodiments of the first aspect of the invention, the second operative temperature is in the range of 180 C to 220 C.

In some embodiments of the first aspect of the invention, the heater is adapted, during operation thereof when the first and second ends of the flexible elongate belt are disposed over the heating surface, and the heat-curable tape is disposed over the first and second ends, to provide a uniform temperature across the heat-curable tape.

In some embodiments of the first aspect of the invention, the uniform temperature is in the range of 130 to 180 C.

In some embodiments of the first aspect of the invention, during operation of the heater, when the first and second ends of the flexible elongate belt are disposed over the heating surface, and the heat-curable tape is disposed over the first and second ends, the heater is adapted to provide the first and the second operative temperatures for a duration of at most 1 minute, thereby to heat-cure the solid silicone rubber of the heat-curable tape.

In some embodiments of the first aspect of the invention, during operation of the heater, when the first and second ends of the flexible elongate belt are disposed over the heating surface, and the heat-curable tape is disposed over the first and second ends, the heater is adapted to provide the first and the second operative temperatures for a duration of at most 3 minutes, thereby to heat-cure the solid silicone rubber of the heat-curable tape.

In some embodiments of the first aspect of the invention, during operation of the heater, when the first and second ends of the flexible elongate belt are disposed over the heating surface, and the heat-curable tape is disposed over the first and second ends, the heater is adapted to provide the first and the second operative temperatures for a duration of at most 5 minutes, thereby to heat-cure the solid silicone rubber of the heat-curable tape.

In some embodiments of the first aspect of the invention, during operation of the heater, when the first and second ends of the flexible elongate belt are disposed over the heating surface, and the heat-curable tape is disposed over the first and second ends, the heater is adapted to provide the first and the second operative temperatures for a duration of at most 10 minutes, thereby to heat-cure the solid silicone rubber of the heat-curable tape.

In some embodiments of the first aspect of the invention, during operation of the heater, when the first and second ends of the flexible elongate belt are disposed over the heating surface, and the heat-curable tape is disposed over the first and second ends, the heater is adapted to provide the first and the second operative temperatures for a duration of at most 15 minutes, thereby to heat-cure the solid silicone rubber of the heat-curable tape.

In some embodiments of the first aspect of the invention, during operation of the heater, when the first and second ends of the flexible elongate belt are disposed over the heating surface, and the heat-curable tape is disposed over the first and second ends, the heater is adapted to provide the first and the second operative temperatures for a duration of at most 20 minutes, thereby to heat-cure the solid silicone rubber of the heat-curable tape.

In some embodiments of the first aspect of the invention, the heater is adapted to reach the first and second operative temperatures within a duration of at most 1 minute.

In some embodiments of the first aspect of the invention, the heater is adapted to reach the first and second operative temperatures within a duration of at most 3 minutes.

In some embodiments of the first aspect of the invention, the heater is adapted to reach the first and second operative temperatures within a duration of at most 5 minutes.

In some embodiments of the first aspect of the invention, the heater is adapted to reach the first and second operative temperatures within a duration of at most 10 minutes.

In some embodiments of the first aspect of the invention, the heater is formed of a metal selected from the group consisting of aluminum, copper, and brass.

In some embodiments of the first aspect of the invention, the heating surface has a heat conductivity in the range of 2.35 W/cmK to 40 W/cmK.

In some embodiments of the first aspect of the invention, the flexible elongate belt has a positioning arrangement removably attached to the first and second ends, the positioning arrangement adapted for positioning the first and second ends of the belt over the heating surface of the heater during heat-curing of the heat-curable tape.

In some embodiments of the first aspect of the invention, the positioning arrangement includes at least one magnetic element, and the heater includes at least one corresponding magnetic element adapted to magnetically attract the at least one magnetic element of the positioning arrangement during the heat-curing of the heat-curable tape.

In some embodiments of the first aspect of the invention, the at least one magnetic element includes a magnetic metal strip removably attached to each of the first and second ends of the flexible elongate belt.

In some embodiments of the first aspect of the invention, the at least one corresponding magnetic element includes at least one samarium cobalt magnet.

In some embodiments of the first aspect of the invention, the positioning arrangement includes a double sided adhesive.

In some embodiments of the first aspect of the invention, the positioning arrangement includes at least one fixing pin, and the heater includes at least one corresponding fixing bore, adapted to receive the at least one fixing pin during the heat-curing of the heat curable tape.

In some embodiments of the first aspect of the invention, the positioning arrangement includes at least one elongate ridge, and the heating surface includes at least one corresponding elongate groove, adapted to receive and engage the at least one elongate ridge during the heat-curing of the heat-curable tape.

In some embodiments of the first aspect of the invention, the positioning arrangement includes an electrostatic force generating arrangement.

In some embodiments of the first aspect of the invention, the positioning arrangement is formed of a non-insulating material. In some embodiments of the first aspect of the invention, the positioning arrangement has a heat conductivity of at least 0.8 W/cmK.

In some embodiments of the first aspect of the invention, the flexible belt includes a rebate at each of the first and second ends, wherein when the rebates are positioned adjacent one another a channel is formed, the channel sized and adapted to accommodate the heat curable tape therein. In some embodiments of the first aspect of the invention, each of the rebates has a depth in the range of 140 μm to 250 μm.

In some embodiments of the first aspect of the invention, a strength of the heat curable tape, following curing thereof, is directly proportional to a heat quantity applied to the solid silicone rubber layer during curing of the tape.

In some embodiments of the first aspect of the invention, following heat-curing of the solid silicone rubber layer of the tape, a 20 mm segment of the endless belt, including the heat-cured tape, is capable of resisting a load of at least 200N, at room temperature.

In some embodiments of the first aspect of the invention, following heat-curing of the solid silicone rubber layer of the tape, a 20 mm segment of the endless belt, including the heat-cured tape, is capable of resisting a load of at least 220N, at room temperature.

In some embodiments of the first aspect of the invention, following heat-curing of the solid silicone rubber layer of the tape, a 20 mm segment of the endless belt, including the heat-cured tape, is capable of resisting a load of at least 250N, at room temperature.

In some embodiments of the first aspect of the invention, following heat-curing of the solid silicone rubber layer of the tape, a 20 mm segment of the endless belt, including the heat-cured tape, is incapable of resisting a load greater than 350N at room temperature.

In some embodiments of the first aspect of the invention, following heat-curing of the solid silicone rubber layer of the tape, a 20 mm segment of the endless belt, including the heat-cured tape, is incapable of resisting a load greater than 380N at room temperature.

In some embodiments of the first aspect of the invention, following heat-curing of the solid silicone rubber layer of the tape, a 20 mm segment of the endless belt, including the heat-cured tape, is incapable of resisting a load greater than 400N, at room temperature.

In some embodiments of the first aspect of the invention, following heat-curing of the solid silicone rubber layer of the tape, a 20 mm segment of the endless belt, including the heat-cured tape, is capable of resisting a load in the range of 250N-350N, at room temperature.

In some embodiments of the first aspect of the invention, following heat-curing of the solid silicone rubber layer of the tape, a 20 mm segment of the endless belt, including the heat-cured tape, is capable of resisting a load in the range of 220N-380N, at room temperature.

In some embodiments of the first aspect of the invention, following heat-curing of the solid silicone rubber layer of the tape, a 20 mm segment of the endless belt, including the heat-cured tape, is capable of resisting a load in the range of 200N-400N, at room temperature.

In some embodiments of the first aspect of the invention, (i) the flexible belt includes a plurality of lateral formations along at least a portion of each lateral edge, and (ii) at least one of the lateral formations on each lateral edge at each one of the free ends of the flexible belt includes an anchoring structure adapted for attachment to an attachment mechanism, which attachment mechanism is adapted for attaching ones of the laterally extending formations at opposing free ends of each lateral edge of the flexible belt.

In some embodiments of the first aspect of the invention, the kit additionally includes at least two attachment mechanisms each adapted to engage at least two anchoring structures at opposing free ends of each lateral edge of the belt and to attach the laterally extending formations associated with the anchoring structures engaged by the attachment mechanism thereby to attach the opposing free ends of each lateral edge of the flexible belt.

In some embodiments of the first aspect of the invention, each anchoring structure includes a crimping-pin-hole extending through a corresponding lateral formation in a direction orthogonal to a surface of the belt, and each attachment mechanism includes a crimping pin having a diameter less than or equal to the diameter of a crimping-pin hole, and adapted to simultaneously engage two crimping-pin holes, one in each of the opposing free ends of one of the lateral edges of the belt.

It is appreciated that any embodiments of the first aspect of the invention may be combined with one another, provided that they are non-contradictory, and that any and all such combinations (i.e. including those not explicitly written for the sake of brevity) and now explicitly contemplated as embodiments of the invention.

There is further provided, in accordance with an embodiment of a second aspect of the invention, a printing system including:
an intermediate transfer member (ITM) including an endless belt, the endless belt including:
   (i) heat-curable tape including a substrate layer and a solid silicone rubber layer disposed thereon, and
   (ii) a flexible elongate belt having first and second ends, the first and second ends connected at a seam by the heat-curable tape;
an image forming station at which droplets of an ink are applied to an outer surface of the intermediate transfer member to form an ink image;
a drying station for drying the ink image to leave an ink residue film; and
an impression station at which the residue film is transferred to a sheet or web substrate sheet.

In some embodiments of the second aspect of the invention, the flexible belt has a length within a range of 1 to 20 meters.

In some embodiments of the second aspect of the invention, the flexible belt has a length within a range of 5 to 20 meters.

In some embodiments of the second aspect of the invention, the flexible belt has a length within a range of 5 to 15 meters.

In some embodiments of the second aspect of the invention, the flexible belt has a length within a range of 5 to 12 meters.

In some embodiments of the second aspect of the invention, the flexible belt has a length within a range of 7 to 12 meters.

In some embodiments of the second aspect of the invention, the flexible belt has a width within a range of 0.1 to 2.0 meters.

In some embodiments of the second aspect of the invention, the flexible belt has a width within a range of 0.3 to 2.0 meters.

In some embodiments of the second aspect of the invention, the flexible belt has a width within a range of 0.5 to 2.0 meters.

In some embodiments of the second aspect of the invention, the flexible belt has a width within a range of 0.75 to 2.0 meters.

In some embodiments of the second aspect of the invention, the flexible belt has a width within a range of 0.75 to 1.5 meters.

In some embodiments of the second aspect of the invention, the flexible belt has a width within a range of 0.75-1.25 meters.

In some embodiments of the second aspect of the invention, the flexible belt has a thickness within a range of 50 to 3000 μm.

In some embodiments of the second aspect of the invention, the flexible belt has a thickness within a range of 100 to 3000 μm.

In some embodiments of the second aspect of the invention, the flexible belt has a thickness within a range of 200 to 3000 μm.

In some embodiments of the second aspect of the invention, the flexible belt has a thickness within a range of 200 to 1500 μm.

In some embodiments of the second aspect of the invention, the flexible belt has a thickness within a range of 300 to 1000 μm.

In some embodiments of the second aspect of the invention, the flexible belt has a thickness within a range of 300 to 800 μm.

In some embodiments of the second aspect of the invention, the flexible belt has a thickness within a range of 300 to 700 μm.

In some embodiments of the second aspect of the invention, the flexible belt has a thickness within a range of 100 to 600 μm.

In some embodiments of the second aspect of the invention, following heat-curing of the solid silicone rubber layer, the heat-curable tape has a tensile strength of at least 8 MPa.

In some embodiments of the second aspect of the invention, following heat-curing of the solid silicone rubber layer, the heat-curable tape has a shore A hardness of at least 45.

In some embodiments of the second aspect of the invention, following heat-curing of the solid silicone rubber layer, the heat-curable tape has a shore A hardness not greater than 80.

In some embodiments of the second aspect of the invention, following heat-curing of the solid silicone rubber layer, the heat-curable tape has a shore A hardness in the range of 45 to 80.

In some embodiments of the second aspect of the invention, following heat-curing of the solid silicone rubber layer, the solid silicone rubber layer has a shore A hardness in the range of 55 to 65.

In some embodiments of the second aspect of the invention, following heat-curing of the solid silicone rubber layer of the heat curable tape, the following properties are true:

the tape has a tensile strength of at least 8 MPa;

the tape has a shore A hardness of at least 45; and

a strength of the heat curable tape is directly proportional to a heat quantity applied to the solid silicone rubber layer during curing of the tape.

In some embodiments of the second aspect of the invention, the solid silicone rubber includes a thermosetting polymer.

In some embodiments of the second aspect of the invention, the thermosetting polymer includes a platinum catalyzed addition-curing solid silicone rubber.

In some embodiments of the second aspect of the invention, the solid silicone rubber has a density in the range of 1.1 to 1.2 g/cm\hat{ }3.

In some embodiments of the second aspect of the invention, the solid silicone rubber has a density of 1.15 g/cm\hat{ }3.

In some embodiments of the second aspect of the invention, the solid silicone rubber has a shelf life of at least one month.

In some embodiments of the second aspect of the invention, the solid silicone rubber has a shelf life of at least six months.

In some embodiments of the second aspect of the invention, the solid silicone rubber has a shelf life of at least one year.

In some embodiments of the second aspect of the invention, a pot life of the heat curable tape is equal to a shelf life of the solid silicone rubber.

In some embodiments of the second aspect of the invention, a pot life of the heat curable tape is at least one month.

In some embodiments of the second aspect of the invention, a pot life of the heat curable tape is at least six months.

In some embodiments of the second aspect of the invention, a pot life of the heat curable tape is at least one year.

In some embodiments of the second aspect of the invention, the substrate layer includes a fiberglass layer.

In some embodiments of the second aspect of the invention, the substrate layer further includes a silicone coating layer, connected to the fiberglass layer.

In some embodiments of the second aspect of the invention, the silicone coating layer has a shore A hardness in the range of 75 to 80.

In some embodiments of the second aspect of the invention, the substrate layer has a thickness in the range of 110 μm to 170 μm.

In some embodiments of the second aspect of the invention, the substrate layer has a thickness of 160 μm.

In some embodiments of the second aspect of the invention, the solid silicone rubber layer has a thickness in the range of 20 μm to 120 μm.

In some embodiments of the second aspect of the invention, a ratio between a thickness of the solid silicone rubber layer and a thickness of the substrate layer is in the range of 0.10 to 0.75.

In some embodiments of the second aspect of the invention, the heat-curable tape has a thickness in the range of 180 μm to 270 μm.

In some embodiments of the second aspect of the invention, a ratio between a thickness of the tape and a thickness of the belt is in the range of 0.15 to 11.15.

In some embodiments of the second aspect of the invention, a length of the heat-curable tape is greater than a width of the flexible belt.

In some embodiments of the second aspect of the invention, a length of the heat-curable tape is in the range of 1200 mm to 1300 mm.

In some embodiments of the second aspect of the invention, a width of the heat curable tape is in the range of 20 mm to 30 mm.

In some embodiments of the second aspect of the invention, a ratio between a width of the tape and a length of the belt is in the range of 0.01 to 0.03.

In some embodiments of the second aspect of the invention, following heat-curing of the solid silicone rubber layer, a 20 mm segment of the endless belt including the heat-cured tape is capable of resisting a load of at least 200N, at room temperature.

In some embodiments of the second aspect of the invention, following heat-curing of the solid silicone rubber layer, a 20 mm segment of the endless belt including the heat-cured tape is capable of resisting a load of at least 220N, at room temperature.

In some embodiments of the second aspect of the invention, following heat-curing of the solid silicone rubber layer, a 20 mm segment of the endless belt including the heat-cured tape is capable of resisting a load of at least 250N, at room temperature.

In some embodiments of the second aspect of the invention, following heat-curing of the solid silicone rubber layer, a 20 mm segment of the endless belt including the heat-cured tape is capable of resisting a load not greater than 350N, at room temperature.

In some embodiments of the second aspect of the invention, following heat-curing of the solid silicone rubber layer, a 20 mm segment of the endless belt including the heat-cured tape is capable of resisting a load not greater than 380N, at room temperature.

In some embodiments of the second aspect of the invention, following heat-curing of the solid silicone rubber layer, a 20 mm segment of the endless belt including the heat-cured tape is capable of resisting a load not greater than 400N, at room temperature.

In some embodiments of the second aspect of the invention, following heat-curing of the solid silicone rubber layer, a 20 mm segment of the endless belt including the heat-cured tape is capable of resisting a load in the range of 250N-350N, at room temperature.

In some embodiments of the second aspect of the invention, following heat-curing of the solid silicone rubber layer, a 20 mm segment of the endless belt including the heat-cured tape is capable of resisting a load in the range of 220N-380N, at room temperature.

In some embodiments of the second aspect of the invention, following heat-curing of the solid silicone rubber layer, a 20 mm segment of the endless belt including the heat-cured tape is capable of resisting a load in the range of 200N-400N, at room temperature.

In some embodiments of the second aspect of the invention, the intermediate transfer member is used for indirect ink-jet printing in the printing system at an operational temperature in the range of 130 C to 170 C for a duration of at least two weeks without failure of the seam.

In some embodiments of the second aspect of the invention, the flexible elongate belt includes a rebate at each of the first and second ends, wherein, in the endless belt, the heat curable tape is accommodated in a channel formed by the rebates being positioned adjacent one another.

In some embodiments of the second aspect of the invention, each of the rebates has a depth in the range of 140 μm to 250 μm.

In some embodiments of the second aspect of the invention, the printing system further includes a heater disposed beneath the intermediate transfer member and adapted to provide heat sufficient for heat-curing the solid silicone rubber of the heat-curable tape thereby to heat-cure the heat curable tape onto the first and second ends to form the endless belt.

In some embodiments of the second aspect of the invention, the heater includes a heating surface having a width greater than a width of the heat-cured tape.

In some embodiments of the second aspect of the invention, the heater forms part of a belt support system of the printing system, and is mounted adjacent rollers adapted to guide the endless belt during operation of the printing system.

In some embodiments of the second aspect of the invention, the heater is designed such that a greater heat density is provided at ends of the heating surface than at a center of the heating surface.

In some embodiments of the second aspect of the invention, the heater includes a plurality of heating elements, the heating elements being unevenly distributed across the heating surface, such that a greater heat density is provided at ends of the heating surface than at a center of the heating surface.

In some embodiments of the second aspect of the invention, the plurality of heating elements are printed on ceramic plates.

In some embodiments of the second aspect of the invention, the plurality of heating elements are printed on filaments.

In some embodiments of the second aspect of the invention, the plurality of heating elements are printed on mica strips.

In some embodiments of the second aspect of the invention, the plurality of heating elements are printed on silicon strips.

In some embodiments of the second aspect of the invention, the heater is adapted, during operation thereof, to provide a first operative temperature at the center of the heating surface, and to provide a second operative temperature at the ends of the heating surface.

In some embodiments of the second aspect of the invention, the first operative temperature is in the range of 140 C to 180 C.

In some embodiments of the second aspect of the invention, the second operative temperature is in the range of 180 C to 220 C.

In some embodiments of the second aspect of the invention, the heater is adapted, during operation thereof when the first and second ends of the flexible elongate belt are disposed over the heating surface, and the heat-curable tape is disposed over the first and second ends, to provide a uniform temperature across the heat-curable tape.

In some embodiments of the second aspect of the invention, the uniform temperature is in the range of 130 C to 180 C.

In some embodiments of the second aspect of the invention, during operation of the heater, when the first and second ends of the flexible elongate belt are disposed over the heating surface, and the heat-curable tape is disposed over the first and second ends, the heater is adapted to provide the first and the second operative temperatures for a duration of at most 1 minute, thereby to heat-cure the solid silicone rubber of the heat-curable tape.

In some embodiments of the second aspect of the invention, during operation of the heater, when the first and second ends of the flexible elongate belt are disposed over the heating surface, and the heat-curable tape is disposed over the first and second ends, the heater is adapted to provide the first and the second operative temperatures for a duration of at most 3 minutes, thereby to heat-cure the solid silicone rubber of the heat-curable tape.

In some embodiments of the second aspect of the invention, during operation of the heater, when the first and second ends of the flexible elongate belt are disposed over the heating surface, and the heat-curable tape is disposed over the first and second ends, the heater is adapted to provide the first and the second operative temperatures for a duration of at most 5 minutes, thereby to heat-cure the solid silicone rubber of the heat-curable tape.

In some embodiments of the second aspect of the invention, during operation of the heater, when the first and second ends of the flexible elongate belt are disposed over the heating surface, and the heat-curable tape is disposed over the first and second ends, the heater is adapted to provide the first and the second operative temperatures for a duration of at most 10 minutes, thereby to heat-cure the solid silicone rubber of the heat-curable tape.

In some embodiments of the second aspect of the invention, during operation of the heater, when the first and second ends of the flexible elongate belt are disposed over the heating surface, and the heat-curable tape is disposed over the first and second ends, the heater is adapted to provide the first and the second operative temperatures for a duration of at most 15 minutes, thereby to heat-cure the solid silicone rubber of the heat-curable tape.

In some embodiments of the second aspect of the invention, during operation of the heater, when the first and second ends of the flexible elongate belt are disposed over the heating surface, and the heat-curable tape is disposed over the first and second ends, the heater is adapted to provide the first and the second operative temperatures for a duration of at most 20 minutes, thereby to heat-cure the solid silicone rubber of the heat-curable tape.

In some embodiments of the second aspect of the invention, the heater is adapted to reach the first and second operative temperatures within a duration of at most 1 minute.

In some embodiments of the second aspect of the invention, the heater is adapted to reach the first and second operative temperatures within a duration of at most 3 minutes.

In some embodiments of the second aspect of the invention, the heater is adapted to reach the first and second operative temperatures within a duration of at most 5 minutes.

In some embodiments of the second aspect of the invention, the heater is adapted to reach the first and second operative temperatures within a duration of at most 10 minutes.

In some embodiments of the second aspect of the invention, the heater is formed of a metal selected from the group consisting of aluminum, copper, and brass.

In some embodiments of the second aspect of the invention, the heating surface has a heat conductivity in the range of 2.35 W/cmK to 40 W/cmK.

In some embodiments of the second aspect of the invention, the flexible elongate belt has a positioning arrangement removably attached to the first and second ends, the positioning arrangement adapted for positioning the first and second ends of the belt over the heating surface of the heater during heat-curing of the heat-curable tape.

In some embodiments of the second aspect of the invention, the positioning arrangement includes at least one magnetic element, and the heater includes at least one corresponding magnetic element adapted to magnetically attract the at least one magnetic element of the positioning arrangement during the heat-curing of the heat-curable tape.

In some embodiments of the second aspect of the invention, the at least one magnetic element includes a magnetic metal strip removably attached to each of the first and second ends of the flexible elongate belt.

In some embodiments of the second aspect of the invention, the at least one corresponding magnetic element includes at least one samarium cobalt magnet.

In some embodiments of the second aspect of the invention, the positioning arrangement includes a double sided adhesive.

In some embodiments of the second aspect of the invention, the positioning arrangement includes at least one fixing pin, and the heater includes at least one corresponding fixing bore, adapted to receive the at least one fixing pin during the heat-curing of the heat curable tape.

In some embodiments of the second aspect of the invention, the positioning arrangement includes at least one elongate ridge, and the heating surface includes at least one corresponding elongate groove, adapted to receive and engage the at least one elongate ridge during the heat-curing of the heat-curable tape.

In some embodiments of the second aspect of the invention, the positioning arrangement includes an electrostatic force generating arrangement.

In some embodiments of the second aspect of the invention, the positioning arrangement is formed of a non-insulating material.

In some embodiments of the second aspect of the invention, the positioning arrangement has a heat conductivity of at least 0.8 W/cmK.

In some embodiments of the second aspect of the invention, a strength of the heat curable tape, following curing thereof, is directly proportional to a heat quantity applied to the solid silicone rubber layer during curing of the tape.

In some embodiments of the second aspect of the invention, (i) the flexible elongate belt includes a plurality of lateral formations along at least a portion of each lateral edge, (ii) at least one of the lateral formations on each lateral edge at each one of the free ends of the flexible belt includes an anchoring structure adapted for attachment to an attachment mechanism, and (iii) the printing system further includes at least two attachment mechanisms each engaging at least two anchoring structures at opposing free ends of one of the lateral edges of the belt and attach the laterally extending formations associated with the at least two anchoring structures, thereby attaching the opposing free ends of each lateral edge of the flexible belt.

In some embodiments of the second aspect of the invention, each anchoring structure includes a crimping-pin-hole extending through a corresponding lateral formation in a direction orthogonal to a surface of the belt, and each attachment mechanism includes a crimping pin having a diameter less than or equal to a diameter of the crimping-pin holes, simultaneously engaging two crimping-pin-holes, one in each of the opposing free ends of one of the lateral edges of the belt.

It is appreciated that any embodiments of the second aspect of the invention may be combined with one another, provided that they are non-contradictory, and that any and all such combinations (i.e. including those not explicitly written for the sake of brevity) and now explicitly contemplated as embodiments of the invention.

There is also provided, in accordance with an embodiment of a third aspect of the invention, a method of forming an endless belt from a flexible belt having first and second free ends the method including:

when the flexible belt is threaded through a belt route of a printing system such that the first and second free ends are positioned over a heater disposed in the printing system, performing the following:
(i) applying a heat-curable tape, including a substrate layer and a solid silicone rubber layer disposed thereon, or respective portions thereof, over the first and second free ends of the flexible belt; and
(ii) heat-curing the solid silicone rubber layer of the heat-curable tape to the first and second free ends of the flexible belt, so as to form a seam connecting the first and second free ends, thereby converting the flexible belt into an endless belt.

In some embodiments of the third aspect of the invention, the flexible belt includes lateral formations along sides thereof, the method further including threading the flexible belt through the belt route by engaging the formations with lateral tracks of the printing system for guiding the flexible belt along the printing system.

In some embodiments of the third aspect of the invention, the method further includes providing the heater beneath the intermediate transfer member, and wherein the heat-curing includes operating the heater to provide heat sufficient for the heat-curing.

In some embodiments of the third aspect of the invention, the method further comprises, following applying the heat-curable tape and prior to the heat curing, applying an adhesive onto and/or around an exposed surface of the heat curable tape so as to seal gaps between the heat curable tape and the belt.

There is additionally provided, in accordance with another embodiment of the third aspect of the invention, a method of forming an endless belt from a flexible belt having first and second free ends the method including:
providing a heat-curable tape, including a substrate layer and a solid silicone rubber layer disposed thereon, or respective portions thereof
providing a heater adapted to provide heat sufficient for heat-curing the solid silicone rubber layer;
threading the flexible belt through a belt route of a printing system to position the first and second free ends over the heater;
applying the heat-curable tape over the first and second free ends of the flexible belt; and
using the heater, heat-curing the solid silicone rubber layer of the heat-curable tape to the first and second free ends of the flexible belt, so as to form a seam connecting the first and second free ends thereby forming an endless belt from the flexible belt.

In some embodiments of the third aspect of the invention, the method further comprises, following applying the heat-curable tape and prior to the heat curing, applying an adhesive onto and/or around an exposed surface of the heat curable tape so as to seal gaps between the heat curable tape and the belt.

In some embodiments of the third aspect of the invention, the flexible belt has a length within a range of 1 to 20 meters.

In some embodiments of the third aspect of the invention, the flexible belt has a length within a range of 5 to 20 meters.

In some embodiments of the third aspect of the invention, the flexible belt has a length within a range of 5 to 15 meters.

In some embodiments of the third aspect of the invention, the flexible belt has a length within a range of 5 to 12 meters.

In some embodiments of the third aspect of the invention, the flexible belt has a length within a range of 7 to 12 meters.

In some embodiments of the third aspect of the invention, the flexible belt has a width within a range of 0.1 to 2.0 meters.

In some embodiments of the third aspect of the invention, the flexible belt has a width within a range of 0.3 to 2.0 meters.

In some embodiments of the third aspect of the invention, the flexible belt has a width within a range of 0.5 to 2.0 meters.

In some embodiments of the third aspect of the invention, the flexible belt has a width within a range of 0.75 to 2.0 meters.

In some embodiments of the third aspect of the invention, the flexible belt has a width within a range of 0.75 to 1.5 meters.

In some embodiments of the third aspect of the invention, the flexible belt has a width within a range of 0.75 to 1.25 meters.

In some embodiments of the third aspect of the invention, the flexible belt has a thickness within a range of 50 to 3000 μm.

In some embodiments of the third aspect of the invention, the flexible belt has a thickness within a range of 100 to 3000 μm.

In some embodiments of the third aspect of the invention, the flexible belt has a thickness within a range of 200 to 3000 μm.

In some embodiments of the third aspect of the invention, the flexible belt has a thickness within a range of 200 to 1500 μm.

In some embodiments of the third aspect of the invention, the flexible belt has a thickness within a range of 300 to 1000 μm.

In some embodiments of the third aspect of the invention, the flexible belt has a thickness within a range of 300 to 800 μm.

In some embodiments of the third aspect of the invention, the flexible belt has a thickness within a range of 300 to 700 μm.

In some embodiments of the third aspect of the invention, the flexible belt has a thickness within a range of 100 to 600 μm.

In some embodiments of the third aspect of the invention, following the heat-curing, the tape has a tensile strength of at least 8 MPa.

In some embodiments of the third aspect of the invention, following the heat-curing, the tape has a shore A hardness of at least 45.

In some embodiments of the third aspect of the invention, following heat-curing of the solid silicone rubber layer, the heat-curable tape has a shore A hardness not greater than 80.

In some embodiments of the third aspect of the invention, following the heat-curing, the tape has a shore A hardness in the range of 45 to 80.

In some embodiments of the third aspect of the invention, following heat-curing of the solid silicone rubber layer, the solid silicone rubber layer has a shore A hardness in the range of 55 to 65.

In some embodiments of the third aspect of the invention, following heat-curing of the solid silicone rubber layer of the heat curable tape, the following properties are true:

the tape has a tensile strength of at least 8 MPa;

the tape has a shore A hardness of at least 45; and

a strength of the heat curable tape is directly proportional to a heat quantity applied to the solid silicone rubber layer during curing of the tape.

In some embodiments of the third aspect of the invention, the solid silicone rubber includes a thermosetting polymer.

In some embodiments of the third aspect of the invention, the thermosetting polymer includes a platinum catalyzed addition-curing solid silicone rubber.

In some embodiments of the third aspect of the invention, the solid silicone rubber has a density in the range of 1.1 to 1.2 g/cm\hat{ }3.

In some embodiments of the third aspect of the invention, the solid silicone rubber has a density of 1.15 g/cm\hat{ }3.

In some embodiments of the third aspect of the invention, the solid silicone rubber has a shelf life of at least one month.

In some embodiments of the third aspect of the invention, the solid silicone rubber has a shelf life of at least six months.

In some embodiments of the third aspect of the invention, the solid silicone rubber has a shelf life of at least one year.

In some embodiments of the third aspect of the invention, a pot life of the heat curable tape is equal to a shelf life of the solid silicone rubber.

In some embodiments of the third aspect of the invention, a pot life of the heat curable tape is at least one month.

In some embodiments of the third aspect of the invention, a pot life of the heat curable tape is at least six months.

In some embodiments of the third aspect of the invention, a pot life of the heat curable tape is at least one year.

In some embodiments of the third aspect of the invention, the substrate layer includes a fiberglass layer.

In some embodiments of the third aspect of the invention, the substrate layer further includes a silicone coating layer, connected to the fiberglass layer.

In some embodiments of the third aspect of the invention, the silicone coating layer has a shore A hardness in the range of 75 to 80. In some embodiments of the third aspect of the invention, the substrate layer has a thickness in the range of 110 μm to 170 μm.

In some embodiments of the third aspect of the invention, the solid silicone rubber layer has a thickness in the range of 20 μm to 120 μm.

In some embodiments of the third aspect of the invention, a ratio between a thickness of the solid silicone rubber layer and a thickness of the substrate layer is in the range of 0.10 to 0.75.

In some embodiments of the third aspect of the invention, the curable tape has a thickness in the range of 180 μm to 270 μm.

In some embodiments of the third aspect of the invention, a ratio between a thickness of the tape and a thickness of the belt is in the range of 0.15 to 11.15.

In some embodiments of the third aspect of the invention, a length of the heat curable tape is greater than a width of the flexible belt.

In some embodiments of the third aspect of the invention, a length of the heat curable tape is in the range of 1200 mm to 1300 mm. In some embodiments of the third aspect of the invention, a width of the heat curable tape is in the range of 20 mm to 30 mm.

In some embodiments of the third aspect of the invention, a ratio between a width of the tape and a length of the belt is in the range of 0.01 to 0.03.

In some embodiments of the third aspect of the invention, the heater includes a heating surface having a width greater than a width of the heat-curable tape.

In some embodiments of the third aspect of the invention, the heat-curing includes activating the heater to provide a temperature of at least 130 C for a duration of at most 1 minute uniformly across the heat-curable tape.

In some embodiments of the third aspect of the invention, the heat-curing includes activating the heater to provide a temperature of at least 130 C for a duration of at most 3 minutes uniformly across the heat-curable tape.

In some embodiments of the third aspect of the invention, the heat-curing includes activating the heater to provide a temperature of at least 130 C for a duration of at most 5 minutes uniformly across the heat-curable tape.

In some embodiments of the third aspect of the invention, the heat-curing includes activating the heater to provide a temperature of at least 130 C for a duration of at most 10 minutes uniformly across the heat-curable tape.

In some embodiments of the third aspect of the invention, the heat-curing includes activating the heater to provide a temperature of at least 130 C for a duration of at most 15 minutes uniformly across the heat-curable tape.

In some embodiments of the third aspect of the invention, the heat-curing includes activating the heater to provide a temperature of at least 130 C for a duration of at most 20 minutes uniformly across the heat-curable tape.

In some embodiments of the third aspect of the invention, the heat-curing includes activating the heater to provide a greater heat density at ends of the heating surface than at a center of the heating surface.

In some embodiments of the third aspect of the invention, the heat-curing includes activating the heater to provide a first operative temperature at a center of a heating surface of the heater, and to provide a second operative temperature at ends of the heating surface of the heater.

In some embodiments of the third aspect of the invention, the first operative temperature is in the range of 140 C to 180 C.

In some embodiments of the third aspect of the invention, the second operative temperature is in the range of 180 C to 220 C.

In some embodiments of the third aspect of the invention, activating the heater includes activating the heater to provide the first and the second operative temperatures for a duration of at most 1 minute, thereby to heat-cure the solid silicone rubber of the heat-curable tape.

In some embodiments of the third aspect of the invention, activating the heater includes activating the heater to provide the first and the second operative temperatures for a duration of at most 3 minutes, thereby to heat-cure the solid silicone rubber of the heat-curable tape.

In some embodiments of the third aspect of the invention, activating the heater includes activating the heater to provide the first and the second operative temperatures for a duration of at most 5 minutes, thereby to heat-cure the solid silicone rubber of the heat-curable tape.

In some embodiments of the third aspect of the invention, activating the heater includes activating the heater to provide the first and the second operative temperatures for a duration of at most 10 minutes, thereby to heat-cure the solid silicone rubber of the heat-curable tape. In some embodiments of the third aspect of the invention, activating the heater includes activating the heater to provide the first and the second operative temperatures for a duration of at most 15 minutes, thereby to heat-cure the solid silicone rubber of the heat-curable tape.

In some embodiments of the third aspect of the invention, activating the heater includes activating the heater to provide the first and the second operative temperatures for a duration of at most 20 minutes, thereby to heat-cure the solid silicone rubber of the heat-curable tape.

In some embodiments of the third aspect of the invention, activating the heater comprises activating the heater such that a temperature of a heating surface of the heater reaches the first and second operative temperatures within a duration of at most 1 minute.

In some embodiments of the third aspect of the invention, activating the heater comprises activating the heater such that a temperature of a heating surface of the heater reaches the first and second operative temperatures within a duration of at most 3 minutes.

In some embodiments of the third aspect of the invention, activating the heater comprises activating the heater such that a temperature of a heating surface of the heater reaches the first and second operative temperatures within a duration of at most 5 minutes.

In some embodiments of the third aspect of the invention, activating the heater comprises activating the heater such that a temperature of a heating surface of the heater reaches the first and second operative temperatures within a duration of at most 10 minutes.

In some embodiments of the third aspect of the invention, the method further includes:
prior to the threading of the flexible belt through the belt route, attaching a positioning arrangement to the first and second free ends; and
prior to the applying the heat-curable tape, using the positioning arrangement, positioning the first and second free ends in a fixed position relative to the heater.

In some embodiments of the third aspect of the invention, the method further includes, following the heat-curing, removing the positioning arrangement from the flexible belt.

In some embodiments of the third aspect of the invention, the positioning arrangement includes at least one magnetic element, and wherein the positioning includes magnetically engaging the at least one magnetic element to at least one corresponding magnetic element of the heater.

In some embodiments of the third aspect of the invention, the positioning arrangement includes a double sided adhesive.

In some embodiments of the third aspect of the invention, the positioning arrangement includes at least one fixing pin, and wherein the positioning includes engaging the at least one fixing pin to a corresponding fixing bore.

In some embodiments of the third aspect of the invention, the positioning arrangement includes at least one elongate ridge, and wherein the positioning includes engaging the at least one elongate ridge to a corresponding groove.

In some embodiments of the third aspect of the invention, the positioning arrangement includes an electrostatic force generating arrangement.

In some embodiments of the third aspect of the invention, the positioning arrangement is formed of a non-insulating material.

In some embodiments of the third aspect of the invention, the positioning arrangement has a heat conductivity of at least 2.35 W/cmK to 40 W/cmK.

In some embodiments of the third aspect of the invention, the method further includes:
prior to the threading of the flexible belt through the belt route, forming a rebate at each of the first and second free ends of the flexible belt; and
following threading of the flexible belt through the belt route, positioning the rebates adjacent one another to form a channel,
wherein applying the heat-curable tape includes accommodating the heat-curable tape in the channel.

In some embodiments of the third aspect of the invention, forming a rebate includes forming a rebate having a depth in the range of 140 μm to 250 μm.

In some embodiments of the third aspect of the invention, a strength of the heat curable tape, following curing thereof, is directly proportional to a heat quantity applied to the solid silicone rubber layer during curing of the tape.

In some embodiments of the third aspect of the invention, following the heat-curing of the solid silicone rubber layer, a 20 mm segment of the endless belt including the tape is capable of resisting a load of at least 200N, at room temperature.

In some embodiments of the third aspect of the invention, following the heat-curing of the solid silicone rubber layer, a 20 mm segment of the endless belt including the tape is capable of resisting a load of at least 220N, at room temperature.

In some embodiments of the third aspect of the invention, following the heat-curing of the solid silicone rubber layer, a 20 mm segment of the endless belt including the tape is capable of resisting a load of at least 250N, at room temperature.

In some embodiments of the third aspect of the invention, following heat-curing of the solid silicone rubber layer, a 20 mm segment of the endless belt including the tape is incapable of resisting a load greater than 350N, at room temperature.

In some embodiments of the third aspect of the invention, following heat-curing of the solid silicone rubber layer, a 20 mm segment of the endless belt including the tape is incapable of resisting a load greater than 380N, at room temperature.

In some embodiments of the third aspect of the invention, following heat-curing of the solid silicone rubber layer, a 20 mm segment of the endless belt including the tape is incapable of resisting a load greater than 400N, at room temperature.

In some embodiments of the third aspect of the invention, following heat-curing of the solid silicone rubber layer, a 20 mm segment of the endless belt including the tape is capable of resisting a load in the range of 250N-350N, at room temperature.

In some embodiments of the third aspect of the invention, following heat-curing of the solid silicone rubber layer, a 20 mm segment of the endless belt including the tape is capable of resisting a load in the range of 220N-380N, at room temperature.

In some embodiments of the third aspect of the invention, following heat-curing of the solid silicone rubber layer, a 20 mm segment of the endless belt including the tape is capable of resisting a load in the range of 200N-400N, at room temperature.

In some embodiments of the third aspect of the invention, the method further includes, following the heat-curing, operating the endless belt in the printing system at an operational temperature of 150 C for a duration of at least two weeks without failure of the seam.

In some embodiments of the third aspect of the invention, the flexible belt includes a plurality of lateral formations along at least a portion of each lateral edge thereof, wherein at least one of the lateral formations on each lateral edge at each one of the free ends of the flexible belt includes an anchoring structure adapted for attachment to an attachment mechanism, the method additionally comprising the step of connecting at least one attachment mechanism to anchoring structures associated with the lateral formations of each of the respective first and second free ends of each lateral side of the belt, so as to attach the first and second free ends of the belt to each other.

In some embodiments of the third aspect of the invention, each anchoring structure includes a crimping-pin-hole extending through the lateral formation in a direction orthogonal to a surface of the belt and each attachment mechanism includes a crimping pin including a pair of upright members, and the step of connecting includes:

(a) inserting two crimping pins, one crimping pin for each lateral edge of the belt, through respective pairs of crimping-pin-holes in the ultimate lateral formations of each of the respective first and second free ends of the belt, so as to hold the first and second free ends of the belt in proximity to each other, and

(b) crimping ends of the upright members of each of the crimping pins.

There is further provided, in accordance with another embodiment of the third aspect of the invention, a method of printing an image onto a substrate in a printing system including a printing station and an impression station, the method including:
in the printing system, forming an endless belt according to the method disclosed herein in the third aspect of the invention;
ink-jet printing an image onto a surface of the endless belt;
rotating the endless belt to move the image from the printing station to the impression station; and
transferring the image from the surface of the endless belt onto the substrate.

It is appreciated that any embodiments of the third aspect of the invention may be combined with one another, provided that they are non-contradictory, and that any and all such combinations (i.e. including those not explicitly written for the sake of brevity) and now explicitly contemplated as embodiments of the invention.

There is also provided, in accordance with an embodiment of a fourth aspect of the invention, a heat-curable tape for connecting first and second ends of a flexible belt so as to form an endless belt to be used in a printing system, the heat-curable tape, including:
a substrate layer; and
a solid silicone rubber layer disposed on the substrate layer.

In some embodiments of the fourth aspect of the invention, a ratio between a thickness of the solid silicone rubber layer and a thickness of the substrate layer is in the range of 0.10 to 0.75.

In some embodiments of the fourth aspect of the invention, following heat-curing of the solid silicone rubber layer, the tape has a tensile strength of at least 8 MPa.

In some embodiments of the fourth aspect of the invention, following heat-curing of the solid silicone rubber layer, the tape has a shore A hardness of at least 45.

In some embodiments of the fourth aspect of the invention, following heat-curing of the solid silicone rubber layer, the heat-curable tape has a shore A hardness not greater than 80.

In some embodiments of the fourth aspect of the invention, following heat-curing of the solid silicone rubber layer, the tape has a shore A hardness in the range of 45 to 80.

In some embodiments of the fourth aspect of the invention, following heat-curing of the solid silicone rubber layer, the solid silicone rubber layer has a shore A hardness in the range of 55 to 65.

In some embodiments of the fourth aspect of the invention, following heat-curing of the solid silicone rubber layer of the heat curable tape, the following properties are true:

the tape has a tensile strength of at least 8 MPa;

the tape has a shore A hardness of at least 45; and

a strength of the heat curable tape is directly proportional to a heat quantity applied to the solid silicone rubber layer during curing of the tape.

In some embodiments of the fourth aspect of the invention, the solid silicone rubber layer includes a thermosetting polymer.

In some embodiments of the fourth aspect of the invention, the solid silicone rubber has a density in the range of 1.1 to 1.2 g/cm\hat{ }3.

In some embodiments of the fourth aspect of the invention, the solid silicone rubber has a density of 1.15 g/cm\hat{ }3.

In some embodiments of the fourth aspect of the invention, the solid silicone rubber has a shelf life of at least one month.

In some embodiments of the fourth aspect of the invention, the solid silicone rubber has a shelf life of at least six months.

In some embodiments of the fourth aspect of the invention, the solid silicone rubber has a shelf life of at least one year.

In some embodiments of the fourth aspect of the invention, a pot life of the heat curable tape is equal to a shelf life of the solid silicone rubber.

In some embodiments of the fourth aspect of the invention, a pot life of the heat curable tape is at least one month.

In some embodiments of the fourth aspect of the invention, a pot life of the heat curable tape is at least six months.

In some embodiments of the fourth aspect of the invention, a pot life of the heat curable tape is at least one year.

In some embodiments of the fourth aspect of the invention, the substrate layer includes a fiberglass layer.

In some embodiments of the fourth aspect of the invention, the substrate layer further includes a silicone coating layer, connected to the fiberglass layer.

In some embodiments of the fourth aspect of the invention, the silicone coating layer has a shore A hardness in the range of 75 to 80.

In some embodiments of the fourth aspect of the invention, the substrate layer has a thickness in the range of 110 μm to 170 μm.

In some embodiments of the fourth aspect of the invention, the solid silicone rubber layer has a thickness in the range of 20 μm to 120 μm.

In some embodiments of the fourth aspect of the invention, the curable tape has a thickness in the range of 180 μm to 270 μm.

In some embodiments of the fourth aspect of the invention, a ratio between a thickness of the heat-curable tape and a thickness of the endless belt is in the range of 0.15 to 11.15.

In some embodiments of the fourth aspect of the invention, a length of the heat curable tape is greater than a width of the flexible belt.

In some embodiments of the fourth aspect of the invention, a length of the heat curable tape is in the range of 1200 mm to 1300 mm.

In some embodiments of the fourth aspect of the invention, a width of the heat curable tape is in the range of 20 mm to 30 mm.

In some embodiments of the fourth aspect of the invention, a ratio between a width of the tape and a length of the endless belt is in the range of 0.01 to 0.03.

In some embodiments of the fourth aspect of the invention, a strength of the heat curable tape, following curing thereof, is directly proportional to a heat quantity applied to the solid silicone rubber layer during curing of the tape.

In some embodiments of the fourth aspect of the invention, following heat-curing of the solid silicone rubber layer of the tape onto the flexible belt, a 20 mm segment of the flexible belt including the tape is capable of resisting a load of at least 200N, at room temperature.

In some embodiments of the fourth aspect of the invention, following heat-curing of the solid silicone rubber layer of the tape onto the flexible belt, a 20 mm segment of the flexible belt including the tape is capable of resisting a load of at least 220N, at room temperature.

In some embodiments of the fourth aspect of the invention, following heat-curing of the solid silicone rubber layer of the tape onto the flexible belt, a 20 mm segment of the flexible belt including the tape is capable of resisting a load of at least 250N, at room temperature.

In some embodiments of the fourth aspect of the invention, following heat-curing of the solid silicone rubber layer of the tape onto the flexible belt, a 20 mm segment of the flexible belt including the tape is incapable of resisting a load greater than 350N, at room temperature.

In some embodiments of the fourth aspect of the invention, following heat-curing of the solid silicone rubber layer of the tape onto the flexible belt, a 20 mm segment of the flexible belt including the tape is incapable of resisting a load greater than 380N, at room temperature.

In some embodiments of the fourth aspect of the invention, following heat-curing of the solid silicone rubber layer of the tape onto the flexible belt, a 20 mm segment of the flexible belt including the tape is incapable of resisting a load greater than 400N, at room temperature.

In some embodiments of the fourth aspect of the invention, following heat-curing of the solid silicone rubber layer of the tape onto the flexible belt, a 20 mm segment of the flexible belt including the tape is capable of resisting a load in the range of 250N-350N, at room temperature.

In some embodiments of the fourth aspect of the invention, following heat-curing of the solid silicone rubber layer of the tape onto the flexible belt, a 20 mm segment of the flexible belt including the tape is capable of resisting a load in the range of 220N-380N, at room temperature.

In some embodiments of the fourth aspect of the invention, following heat-curing of the solid silicone rubber layer of the tape onto the flexible belt, a 20 mm segment of the flexible belt including the tape is capable of resisting a load in the range of 200N-400N, at room temperature.

It is appreciated that any embodiments of the fourth aspect of the invention may be combined with one another, provided that they are non-contradictory, and that any and all such combinations (i.e. including those not explicitly written for the sake of brevity) and now explicitly contemplated as embodiments of the invention.

There is further provided, in accordance with an embodiment of a fifth aspect of the invention, a printing system including:
an intermediate transfer member (ITM) including an endless belt, the endless belt including a flexible elongate belt having first and second ends, the first and second ends connected by a seam;
a heater disposed beneath the intermediate transfer member and adapted to provide heat sufficient for attaching the seam to the first and second ends;
an image forming station at which droplets of an ink are applied to an outer surface of the intermediate transfer member to form an ink image;
a drying station for drying the ink image to leave an ink residue film; and
an impression station at which the residue film is transferred to a sheet or web substrate sheet.

In some embodiments of the fifth aspect of the invention, the seam includes a heat curable adhesive and wherein the heater is adapted to provide heat sufficient for heat-curing the heat-curable adhesive of the seam.

In some embodiments of the fifth aspect of the invention, the heater including a heating surface having a width greater than a width of the seam.

In some embodiments of the fifth aspect of the invention, the heater forms part of a belt support system of the printing system, and is mounted adjacent rollers adapted to guide the endless belt during operation of the printing system.

In some embodiments of the fifth aspect of the invention, the heater is designed such that a greater heat density is provided at ends of the heating surface than at a center of the heating surface.

In some embodiments of the fifth aspect of the invention, the heater includes a plurality of heating elements, the heating elements being unevenly distributed across the heating surface, such that a greater heat density is provided at ends of the heating surface than at a center of the heating surface.

In some embodiments of the fifth aspect of the invention, the heating elements are printed on ceramic plates.

In some embodiments of the fifth aspect of the invention, the heating elements are printed on filaments.

In some embodiments of the fifth aspect of the invention, the heating elements are printed on mica strips.

In some embodiments of the fifth aspect of the invention, the heating elements are printed on silicon strips.

In some embodiments of the fifth aspect of the invention, the heater is adapted, during operation thereof, to provide a first operative temperature at the center of the heating surface, and to provide a second operative temperature at the ends of the heating surface.

In some embodiments of the fifth aspect of the invention, the first operative temperature is in the range of 140 C to 180 C.

In some embodiments of the fifth aspect of the invention, the second operative temperature is in the range of 180 C to 220 C.

In some embodiments of the fifth aspect of the invention, during operation of the heater, when the first and second ends of the flexible elongate belt are disposed over the heating surface, and the seam is disposed over the first and second ends, the heater is adapted to provide the first and the second operative temperatures for a duration of at most 1 minute, thereby to heat-cure the seam.

In some embodiments of the fifth aspect of the invention, during operation of the heater, when the first and second ends of the flexible elongate belt are disposed over the heating surface, and the seam is disposed over the first and second ends, the heater is adapted to provide the first and the second operative temperatures for a duration of at most 3 minutes, thereby to heat-cure the seam.

In some embodiments of the fifth aspect of the invention, during operation of the heater, when the first and second ends of the flexible elongate belt are disposed over the heating surface, and the seam is disposed over the first and second ends, the heater is adapted to provide the first and the second operative temperatures for a duration of at most 5 minutes, thereby to heat-cure the seam.

In some embodiments of the fifth aspect of the invention, during operation of the heater, when the first and second ends of the flexible elongate belt are disposed over the heating surface, and the seam is disposed over the first and second ends, the heater is adapted to provide the first and the second operative temperatures for a duration of at most 10 minutes, thereby to heat-cure the seam.

In some embodiments of the fifth aspect of the invention, during operation of the heater, when the first and second ends of the flexible elongate belt are disposed over the heating surface, and the seam is disposed over the first and second ends, the heater is adapted to provide the first and the second operative temperatures for a duration of at most 15 minutes, thereby to heat-cure the seam.

In some embodiments of the fifth aspect of the invention, during operation of the heater, when the first and second ends of the flexible elongate belt are disposed over the heating surface, and the seam is disposed over the first and second ends, the heater is adapted to provide the first and the second operative temperatures for a duration of at most 20 minutes, thereby to heat-cure the seam.

In some embodiments of the fifth aspect of the invention, the heater is adapted to reach the first and second operative temperatures within a duration of at most 1 minute.

In some embodiments of the fifth aspect of the invention, the heater is adapted to reach the first and second operative temperatures within a duration of at most 3 minutes.

In some embodiments of the fifth aspect of the invention, the heater is adapted to reach the first and second operative temperatures within a duration of at most 5 minutes.

In some embodiments of the fifth aspect of the invention, the heater is adapted to reach the first and second operative temperatures within a duration of at most 10 minutes.

In some embodiments of the fifth aspect of the invention, the heater is adapted, during operation thereof when the first and second ends of the flexible elongate belt are disposed over the heating surface, and the seam is disposed over the first and second ends, to provide a uniform temperature across the seam.

In some embodiments of the fifth aspect of the invention, the uniform temperature is in the range of 130 C to 180 C.

In some embodiments of the fifth aspect of the invention, the heating surface is formed of a metal selected from the group consisting of aluminum, copper, and brass.

In some embodiments of the fifth aspect of the invention, the heating surface has a heat conductivity in the range of 2.35 W/cmK to 40 W/cmK.

In some embodiments of the fifth aspect of the invention, the flexible belt has a length within a range of 1 to 20 meters.

In some embodiments of the fifth aspect of the invention, the flexible belt has a length within a range of 5 to 20 meters.

In some embodiments of the fifth aspect of the invention, the flexible belt has a length within a range of 5 to 15 meters.

In some embodiments of the fifth aspect of the invention, the flexible belt has a length within a range of 5 to 12 meters.

In some embodiments of the fifth aspect of the invention, the flexible belt has a length within a range of 7 to 12 meters.

In some embodiments of the fifth aspect of the invention, the flexible belt has a width within a range of 0.1 to 2.0 meters.

In some embodiments of the fifth aspect of the invention, the flexible belt has a width within a range of 0.3 to 2.0 meters.

In some embodiments of the fifth aspect of the invention, the flexible belt has a width within a range of 0.5 to 2.0 meters.

In some embodiments of the fifth aspect of the invention, the flexible belt has a width within a range of 0.75 to 2.0 meters.

In some embodiments of the fifth aspect of the invention, the flexible belt has a width within a range of 0.75 to 1.5 meters.

In some embodiments of the fifth aspect of the invention, the flexible belt has a width within a range of 0.75 to 1.25 meters.

In some embodiments of the fifth aspect of the invention, the flexible belt has a thickness within a range of 50 to 3000 μm.

In some embodiments of the fifth aspect of the invention, the flexible belt has a thickness within a range of 100 to 3000 mm.

In some embodiments of the fifth aspect of the invention, the flexible belt has a thickness within a range of 200 to 3000 mm.

In some embodiments of the fifth aspect of the invention, the flexible belt has a thickness within a range of 200 to 1500 mm.

In some embodiments of the fifth aspect of the invention, the flexible belt has a thickness within a range of 300 to 1000 mm.

In some embodiments of the fifth aspect of the invention, the flexible belt has a thickness within a range of 300 to 800 μm.

In some embodiments of the fifth aspect of the invention, the flexible belt has a thickness within a range of 300 to 700 μm.

In some embodiments of the fifth aspect of the invention, the flexible belt has a thickness within a range of 100 to 600 μm.

In some embodiments of the fifth aspect of the invention, the intermediate transfer member is used for indirect ink-jet printing in the printing system at an operational temperature in the range of 130 C to 170 C for a duration of at least two weeks without failure of the seam.

In some embodiments of the fifth aspect of the invention, the flexible elongate belt has a positioning arrangement removably attached to the first and second ends, the positioning arrangement adapted for positioning the first and second ends of the flexible belt over the heater during heat-curing of the heat-curable adhesive.

In some embodiments of the fifth aspect of the invention, the positioning arrangement includes at least one magnetic element, and the heater includes at least one corresponding magnetic element adapted to magnetically attract the at least one magnetic element of the positioning arrangement during the heat-curing of the heat-curable adhesive.

In some embodiments of the fifth aspect of the invention, the at least one magnetic element includes a magnetic metal strip removably attached to each of the first and second ends of the flexible elongate belt.

In some embodiments of the fifth aspect of the invention, the at least one corresponding magnetic element includes at least one samarium cobalt magnet.

In some embodiments of the fifth aspect of the invention, the positioning arrangement includes a double sided adhesive.

In some embodiments of the fifth aspect of the invention, the positioning arrangement includes at least one fixing pin, and the heater includes at least one corresponding fixing bore, adapted to receive the at least one fixing pin during the heat-curing of the heat curable adhesive.

In some embodiments of the fifth aspect of the invention, the positioning arrangement includes at least one elongate ridge, and the heating surface includes at least one corresponding elongate groove, adapted to receive and engage the at least one elongate ridge during the heat-curing of the heat-curable adhesive.

In some embodiments of the fifth aspect of the invention, the positioning arrangement includes an electrostatic force generating arrangement.

In some embodiments of the fifth aspect of the invention, the positioning arrangement is formed of a non-insulating material. In some embodiments of the fifth aspect of the invention, the positioning arrangement has a heat conductivity of at least 0.8 W/cmK.

In some embodiments of the fifth aspect of the invention, (i) the endless belt includes a plurality of lateral formations along at least a portion of each lateral edge, (ii) at least one of the lateral formations on each lateral edge at each one of the free ends of the flexible belt includes an anchoring structure, and (iii) at least two attachment mechanisms each engaging at least two anchoring structures associated with laterally extending formations at each one of the opposing free ends of a lateral edge of the belt and attaching the laterally extending formations associated with the at least two anchoring structures to each other, thereby attaching the opposing free ends on each lateral edge of the flexible belt

In some embodiments of the fifth aspect of the invention, the anchoring structure includes a crimping-pin-hole extending through the laterally extending formation in a direction orthogonal to a surface of the belt and each attachment mechanism includes a crimping pin having a diameter less than or equal to the diameter of the crimping-pin-holes, simultaneously engaging two crimping-pin-holes, one in each of the free ends of one of the lateral edges of the belt.

There is also provided, in accordance with a further embodiment of the fifth aspect of the present invention, a method of forming the endless belt of the printing system according to the fifth aspect of the present invention, the method including:
threading the flexible elongate belt through a belt route of the printing system, such that the first and second ends of the flexible elongate belt are placed adjacent one another over the heater;
applying the seam over the first and second free ends of the flexible belt; and
using the heater, attaching the seam to the first and second free ends of the flexible belt, so as to connect the first and second free ends thereby converting the flexible belt into an endless belt.

There is further provided, in accordance with another embodiment of the fifth aspect of the invention, a method of forming the endless belt of the printing system of the fifth aspect of the invention, the method including:
attaching the positioning arrangement to the first and second free ends of the flexible belt;
threading the flexible elongate belt through a belt route of the printing system, such that the first and second ends of the flexible elongate belt are placed adjacent one another over the heater;
using the positioning arrangement, positioning the first and second free ends in a fixed position relative to the heater;
applying the seam over the first and second free ends of the flexible belt; and
using the heater, attaching the seam to the first and second free ends of the flexible belt, so as to connect the first and second free ends thereby converting the flexible belt into an endless belt.

In some embodiments of the fifth aspect of the invention, the method further includes, following the attaching, removing the positioning arrangement from the flexible belt.

In some embodiments of the fifth aspect of the invention, the method further includes prior to threading of the flexible belt through the belt route, forming a rebate at each of the first and second free ends of the flexible belt; and following threading of the flexible belt through the belt route, positioning the rebates adjacent one another to form a channel, wherein the applying the seam includes placing the seam in the channel.

In some embodiments of the fifth aspect of the invention, forming a rebate includes forming a rebate having a depth in the range of 140 μm to 250 μm.

In some embodiments of the fifth aspect of the invention, attaching includes operating the heater to provide a greater heat density at ends of the heater than at a center of the heater.

In some embodiments of the fifth aspect of the invention, attaching includes operating the heater to provide a first operative temperature at a center of the heater, and to provide a second operative temperature at ends of the heater.

In some embodiments of the fifth aspect of the invention, the first operative temperature is in the range of 140 C to 180 C.

In some embodiments of the fifth aspect of the invention, the second operative temperature is in the range of 180 C to 220 C.

In some embodiments of the fifth aspect of the invention, the flexible belt includes a plurality of lateral formations along at least a portion of each lateral edge thereof, wherein at least one of the lateral formations on each lateral edge at each one of the free ends of the flexible belt includes an anchoring structure, the method additionally comprising the step of connecting at least one the attachment mechanism to anchoring structures associated with the lateral formations of each of the respective first and second free ends of each lateral side of the belt, so as to attach the first and second free ends of the belt to each other.

In some embodiments of the fifth aspect of the invention, each anchoring structure includes a crimping-pin-hole extending through the lateral formation in a direction orthogonal to a surface of the belt and each attachment mechanism includes a crimping pin including a pair of upright members, wherein the connecting comprises:

a. inserting two crimping pins, one crimping pin for each lateral edge of the belt, through respective pairs of crimping-pin-holes in the ultimate lateral formations of each of the respective first and second free ends of the belt, so as to hold the first and second free ends of the belt in proximity to each other, and
b. crimping ends of the upright members of each of the crimping pins.

There is further provided, in accordance with another embodiment of the fifth aspect of the invention, a method of printing an image onto a substrate in a printing system including a printing station and an impression station, the method including:
in the printing system, forming an endless belt according to the method of the fifth aspect of the invention;
ink-jet printing an image onto a surface of the endless belt;
rotating the endless belt to move the image from the printing station to the impression station; and
transferring the image from the surface of the endless belt onto the substrate.

It is appreciated that any embodiments of the fifth aspect of the invention may be combined with one another, provided that they are non-contradictory, and that any and all such combinations (i.e. including those not explicitly written for the sake of brevity) and now explicitly contemplated as embodiments of the invention.

There is additionally provided, in accordance with an embodiment of a sixth aspect of the invention, a kit for installing an endless belt in a printing system, the kit including:
a heat-curable tape, including a substrate layer and a solid silicone rubber layer disposed thereon; and
an adhesive;

wherein the heat-curable tape is adapted to be applied onto first and second free ends of a flexible belt, and to be heated so as to heat-cure the solid silicone rubber layer of the tape to the first and second free ends of the flexible belt, so as to form a seam connecting the first and second free ends thereby converting the flexible belt into the endless belt, and

wherein the adhesive is adapted to fill and seal gaps between the heat-curable tape and at least a portion of the flexible belt when the heat-curable tape is cured.

In some embodiments of the sixth aspect of the invention, the adhesive is adapted to be applied onto and around an exposed surface of the heat-curable tape, when the heat-curable tape is applied onto the first and second free ends of the flexible belt.

In some embodiments of the sixth aspect of the invention, the adhesive includes a two component adhesive, the two components adapted to be mixed prior to application thereof onto the heat-curable tape.

In some embodiments of the sixth aspect of the invention, following heat-curing of the solid silicone rubber layer, the tape has a tensile strength of at least 8 MPa.

In some embodiments of the sixth aspect of the invention, following heat-curing of the solid silicone rubber layer, the tape has a shore A hardness of at least 45.

In some embodiments of the sixth aspect of the invention, following heat-curing of the solid silicone rubber layer, the heat-curable tape has a shore A hardness not greater than 80.

In some embodiments of the sixth aspect of the invention, following heat-curing of the solid silicone rubber layer, the tape has a shore A hardness in the range of 45 to 80.

In some embodiments of the sixth aspect of the invention, following heat-curing of the solid silicone rubber layer, the solid silicone rubber layer has a shore A hardness in the range of 55 to 65.

In some embodiments of the sixth aspect of the invention, following heat-curing of the solid silicone rubber layer of the heat curable tape, the following properties are true:

the tape has a tensile strength of at least 8 MPa;

the tape has a shore A hardness of at least 45; and

a strength of the heat curable tape is directly proportional to a heat quantity applied to the solid silicone rubber layer during curing of the tape.

In some embodiments of the sixth aspect of the invention, the solid silicone rubber includes a thermosetting polymer.

In some embodiments of the sixth aspect of the invention, the thermosetting polymer includes a platinum catalyzed addition-curing solid silicone rubber.

In some embodiments of the sixth aspect of the invention, the solid silicone rubber has a density in the range of 1.1 to 1.2 g/cm\hat{ }3.

In some embodiments of the sixth aspect of the invention, the solid silicone rubber has a density of 1.15 g/cm\hat{ }3.

In some embodiments of the sixth aspect of the invention, the solid silicone rubber has a shelf life of at least one month.

In some embodiments of the sixth aspect of the invention, the solid silicone rubber has a shelf life of at least six months.

In some embodiments of the sixth aspect of the invention, the solid silicone rubber has a shelf life of at least one year.

In some embodiments of the sixth aspect of the invention, a pot life of the heat curable tape is equal to a shelf life of the solid silicone rubber.

In some embodiments of the sixth aspect of the invention, a pot life of the heat curable tape is at least one month.

In some embodiments of the sixth aspect of the invention, a pot life of the heat curable tape is at least six months.

In some embodiments of the sixth aspect of the invention, a pot life of the heat curable tape is at least one year.

In some embodiments of the sixth aspect of the invention, the substrate layer includes a fiberglass layer.

In some embodiments of the sixth aspect of the invention, the substrate layer further includes a silicone coating layer, connected to the fiberglass layer.

In some embodiments of the sixth aspect of the invention, the silicone coating layer has a shore A hardness in the range of 75 to 80.

In some embodiments of the sixth aspect of the invention, the substrate layer has a thickness in the range of 110 μm to 170 μm.

In some embodiments of the sixth aspect of the invention, the solid silicone rubber layer has a thickness in the range of 20 μm to 120 μm.

In some embodiments of the sixth aspect of the invention, a ratio between a thickness of the solid silicone rubber layer and a thickness of the substrate layer is in the range of 0.10 to 0.75.

In some embodiments of the sixth aspect of the invention, the curable tape has a thickness in the range of 180 μm to 270 μm.

In some embodiments of the sixth aspect of the invention, a length of the heat curable tape is in the range of 1200 mm to 1300 mm.

In some embodiments of the sixth aspect of the invention, a width of the heat curable tape is in the range of 20 mm to 30 mm.

In some embodiments of the sixth aspect of the invention, the kit further includes the flexible belt having the first and second free ends, the flexible belt configured to be guided along the printing system.

In some embodiments of the sixth aspect of the invention, the flexible belt has a length within a range of 1 to 20 meters.

In some embodiments of the sixth aspect of the invention, the flexible belt has a length within a range of 5 to 20 meters.

In some embodiments of the sixth aspect of the invention, the flexible belt has a length within a range of 5 to 15 meters.

In some embodiments of the sixth aspect of the invention, the flexible belt has a length within a range of 5 to 12 meters.

In some embodiments of the sixth aspect of the invention, the flexible belt has a length within a range of 7 to 12 meters.

In some embodiments of the sixth aspect of the invention, the flexible belt has a width within a range of 0.1 to 2.0 meters.

In some embodiments of the sixth aspect of the invention, the flexible belt has a width within a range of 0.3 to 2.0 meters.

In some embodiments of the sixth aspect of the invention, the flexible belt has a width within a range of 0.5 to 2.0 meters.

In some embodiments of the sixth aspect of the invention, the flexible belt has a width within a range of 0.75 to 2.0 meters.

In some embodiments of the sixth aspect of the invention, the flexible belt has a width within a range of 0.75 to 1.5 meters.

In some embodiments of the sixth aspect of the invention, the flexible belt has a width within a range of 0.75-1.25 meters.

In some embodiments of the sixth aspect of the invention, the flexible belt has a thickness within a range of 50 to 3000 μm.

In some embodiments of the sixth aspect of the invention, the flexible belt has a thickness within a range of 100 to 3000 μm.

In some embodiments of the sixth aspect of the invention, the flexible belt has a thickness within a range of 200 to 3000 μm.

In some embodiments of the sixth aspect of the invention, the flexible belt has a thickness within a range of 200 to 1500 μm.

In some embodiments of the sixth aspect of the invention, the flexible belt has a thickness within a range of 300 to 1000 μm.

In some embodiments of the sixth aspect of the invention, the flexible belt has a thickness within a range of 300 to 800 μm.

In some embodiments of the sixth aspect of the invention, the flexible belt has a thickness within a range of 300 to 700 μm.

In some embodiments of the sixth aspect of the invention, the flexible belt has a thickness within a range of 100 to 600 μm.

In some embodiments of the sixth aspect of the invention, a ratio between a thickness of the tape and a thickness of the belt is in the range of 0.15 to 11.15.

In some embodiments of the sixth aspect of the invention, a length of the heat curable tape is greater than a width of the flexible belt.

In some embodiments of the sixth aspect of the invention, a ratio between a width of the tape and a length of the belt is in the range of 0.01 to 0.03.

In some embodiments of the sixth aspect of the invention, the kit further includes a heater adapted to be disposed beneath the heat curable tape when the heat curable tape is applied to the first and second ends of the flexible belt, and adapted to provide heat sufficient for heat-curing the solid silicone rubber of the heat-curable tape thereby to heat-cure the heat curable tape to form the endless belt.

In some embodiments of the sixth aspect of the invention, the heater includes a heating surface having a width greater than a width of the heat-cured tape.

In some embodiments of the sixth aspect of the invention, the heater is designed such that a greater heat density is provided at ends of the heating surface than at a center of the heating surface.

In some embodiments of the sixth aspect of the invention, the heater includes a plurality of heating elements, the heating elements being unevenly distributed across the heating surface, such that a greater heat density is provided at ends of the heating surface than at a center of the heating surface.

In some embodiments of the sixth aspect of the invention, the plurality of heating elements are printed on ceramic plates.

In some embodiments of the sixth aspect of the invention, the plurality of heating elements are printed on filaments.

In some embodiments of the sixth aspect of the invention, the plurality of heating elements are printed on mica strips.

In some embodiments of the sixth aspect of the invention, the plurality of heating elements are printed on silicon strips.

In some embodiments of the sixth aspect of the invention, the heater is adapted, during operation thereof, to provide a first operative temperature at the center of the heating surface, and to provide a second operative temperature at the ends of the heating surface.

In some embodiments of the sixth aspect of the invention, the first operative temperature is in the range of 140 C to 180 C.

In some embodiments of the sixth aspect of the invention, the second operative temperature is in the range of 180 C to 220 C.

In some embodiments of the sixth aspect of the invention, the heater is adapted, during operation thereof when the first and second ends of the flexible elongate belt are disposed over the heating surface, and the heat-curable tape is disposed over the first and second ends, to provide a uniform temperature across the heat-curable tape.

In some embodiments of the sixth aspect of the invention, the uniform temperature is in the range of 130 C to 180 C.

In some embodiments of the sixth aspect of the invention, during operation of the heater, when the first and second ends of the flexible elongate belt are disposed over the heating surface, and the heat-curable tape is disposed over the first and second ends, the heater is adapted to provide the first and the second operative temperatures for a duration of at most 1 minute, thereby to heat-cure the solid silicone rubber of the heat-curable tape.

In some embodiments of the sixth aspect of the invention, during operation of the heater, when the first and second ends of the flexible elongate belt are disposed over the heating surface, and the heat-curable tape is disposed over the first and second ends, the heater is adapted to provide the first and the second operative temperatures for a duration of at most 3 minutes, thereby to heat-cure the solid silicone rubber of the heat-curable tape.

In some embodiments of the sixth aspect of the invention, during operation of the heater, when the first and second ends of the flexible elongate belt are disposed over the heating surface, and the heat-curable tape is disposed over the first and second ends, the heater is adapted to provide the first and the second operative temperatures for a duration of at most 5 minutes, thereby to heat-cure the solid silicone rubber of the heat-curable tape.

In some embodiments of the sixth aspect of the invention, during operation of the heater, when the first and second ends of the flexible elongate belt are disposed over the heating surface, and the heat-curable tape is disposed over the first and second ends, the heater is adapted to provide the first and the second operative temperatures for a duration of at most 10 minutes, thereby to heat-cure the solid silicone rubber of the heat-curable tape.

In some embodiments of the sixth aspect of the invention, during operation of the heater, when the first and second ends of the flexible elongate belt are disposed over the heating surface, and the heat-curable tape is disposed over the first and second ends, the heater is adapted to provide the first and the second operative temperatures for a duration of at most 15 minutes, thereby to heat-cure the solid silicone rubber of the heat-curable tape.

In some embodiments of the sixth aspect of the invention, during operation of the heater, when the first and second ends of the flexible elongate belt are disposed over the heating surface, and the heat-curable tape is disposed over the first and second ends, the heater is adapted to provide the first and the second operative temperatures for a duration of at most 20 minutes, thereby to heat-cure the solid silicone rubber of the heat-curable tape.

In some embodiments of the sixth aspect of the invention, the heater is adapted to reach the first and second operative temperatures within a duration of at most 1 minute.

In some embodiments of the sixth aspect of the invention, the heater is adapted to reach the first and second operative temperatures within a duration of at most 3 minutes.

In some embodiments of the sixth aspect of the invention, the heater is adapted to reach the first and second operative temperatures within a duration of at most 5 minutes.

In some embodiments of the sixth aspect of the invention, the heater is adapted to reach the first and second operative temperatures within a duration of at most 10 minutes.

In some embodiments of the sixth aspect of the invention, the heater is formed of a metal selected from the group consisting of aluminum, copper, and brass.

In some embodiments of the sixth aspect of the invention, the heating surface has a heat conductivity in the range of 2.35 W/cmK to 40 W/cmK.

In some embodiments of the sixth aspect of the invention, the flexible elongate belt has a positioning arrangement removably attached to the first and second ends, the positioning arrangement adapted for positioning the first and second ends of the belt over the heating surface of the heater during heat-curing of the heat-curable tape.

In some embodiments of the sixth aspect of the invention, the positioning arrangement includes at least one magnetic element, and the heater includes at least one corresponding magnetic element adapted to magnetically attract the at least one magnetic element of the positioning arrangement during the heat-curing of the heat-curable tape.

In some embodiments of the sixth aspect of the invention, the at least one magnetic element includes a magnetic metal strip removably attached to each of the first and second ends of the flexible elongate belt.

In some embodiments of the sixth aspect of the invention, the at least one corresponding magnetic element includes at least one samarium cobalt magnet.

In some embodiments of the sixth aspect of the invention, the positioning arrangement includes a double sided adhesive.

In some embodiments of the sixth aspect of the invention, the positioning arrangement includes at least one fixing pin, and the heater includes at least one corresponding fixing bore, adapted to receive the at least one fixing pin during the heat-curing of the heat curable tape.

In some embodiments of the sixth aspect of the invention, the positioning arrangement includes at least one elongate ridge, and the heating surface includes at least one corresponding elongate groove, adapted to receive and engage the at least one elongate ridge during the heat-curing of the heat-curable tape.

In some embodiments of the sixth aspect of the invention, the positioning arrangement includes an electrostatic force generating arrangement.

In some embodiments of the sixth aspect of the invention, wherein the positioning arrangement is formed of a non-insulating material.

In some embodiments of the sixth aspect of the invention, the positioning arrangement has a heat conductivity of at least 0.8 W/cmK.

In some embodiments of the sixth aspect of the invention, the flexible belt includes a rebate at each of the first and second ends, wherein when the rebates are positioned adjacent one another a channel is formed, the channel sized and adapted to accommodate the heat curable tape therein.

In some embodiments of the sixth aspect of the invention, each rebate has a depth in the range of 140 μm to 250 μm.

In some embodiments of the sixth aspect of the invention, a strength of the heat curable tape, following curing thereof, is directly proportional to a heat quantity applied to the solid silicone rubber layer during curing of the tape.

In some embodiments of the sixth aspect of the invention, following heat-curing of the solid silicone rubber layer of the tape, a 20 mm segment of the endless belt, including the heat-cured tape, is capable of resisting a load of at least 200N, at room temperature.

In some embodiments of the sixth aspect of the invention, following heat-curing of the solid silicone rubber layer of the tape, a 20 mm segment of the endless belt, including the heat-cured tape, is capable of resisting a load of at least 220N, at room temperature.

In some embodiments of the sixth aspect of the invention, following heat-curing of the solid silicone rubber layer of the tape, a 20 mm segment of the endless belt, including the heat-cured tape, is capable of resisting a load of at least 250N, at room temperature.

In some embodiments of the sixth aspect of the invention, following heat-curing of the solid silicone rubber layer of the tape, a 20 mm segment of the endless belt, including the heat-cured tape, is incapable of resisting a load greater than 350N, at room temperature.

In some embodiments of the sixth aspect of the invention, following heat-curing of the solid silicone rubber layer of the tape, a 20 mm segment of the endless belt, including the heat-cured tape, is incapable of resisting a load greater than 380N, at room temperature.

In some embodiments of the sixth aspect of the invention, following heat-curing of the solid silicone rubber layer of the tape, a 20 mm segment of the endless belt, including the heat-cured tape, is incapable of resisting a load greater than 400N, at room temperature.

In some embodiments of the sixth aspect of the invention, following heat-curing of the solid silicone rubber layer of the tape, a 20 mm segment of the endless belt, including the heat-cured tape, is capable of resisting a load in the range of 250N-350N, at room temperature.

In some embodiments of the sixth aspect of the invention, following heat-curing of the solid silicone rubber layer of the tape, a 20 mm segment of the endless belt, including the heat-cured tape, is capable of resisting a load in the range of 220N-380N, at room temperature.

In some embodiments of the sixth aspect of the invention, following heat-curing of the solid silicone rubber layer of the tape, a 20 mm segment of the endless belt, including the heat-cured tape, is capable of resisting a load in the range of 200N-400N, at room temperature.

In some embodiments of the sixth aspect of the invention, (i) the flexible belt includes a plurality of lateral formations along at least a portion of each lateral edge, and (ii) at least one of the lateral formations on each lateral edge at each one of the free ends of the flexible belt includes an anchoring structure adapted for attachment to an attachment mechanism, which attachment mechanism is adapted for attaching ones of the lateral formations at opposing free ends of each lateral edge of the flexible belt.

In some embodiments of the sixth aspect of the invention, the kit additionally includes at least two attachment mechanisms each adapted to engage at least two anchoring structures at opposing free ends of each lateral edge of the belt and to attach the laterally extending formations associated with the anchoring structures engaged by the attachment mechanism, thereby to attach the opposing free ends of each lateral edge of the flexible belt.

In some embodiments of the sixth aspect of the invention, each anchoring structure includes a crimping-pin-hole extending through a corresponding laterally extending formation in a direction orthogonal to a surface of the belt, and each attachment mechanism includes a crimping pin having a diameter less than or equal to a diameter of a crimping-pin-hole and adapted to simultaneously engage two crimping-pin-holes, one in each of the opposing free ends of one of the lateral edges of the belt.

It is appreciated that any embodiments of the sixth aspect of the invention may be combined with one another, provided that they are non-contradictory, and that any and all such combinations (i.e. including those not explicitly written for the sake of brevity) and now explicitly contemplated as embodiments of the invention.

There is additionally provided, in accordance with an embodiment of a seventh aspect of the invention, a kit for installing an endless belt in a printing system, the kit including:
a flexible belt having first and second free ends configured to be guided along the printing system, the flexible belt includes a plurality of lateral formations along at least a portion of each lateral edge thereof,

wherein at least one of the lateral formations on each lateral edge at each one of the free ends of the flexible belt includes an anchoring structure adapted for attachment to an attachment mechanism, and
at least two attachment mechanisms each adapted to engage at least two the anchoring structures at opposing free ends of each lateral edge of the belt and to attach the laterally extending formations associated with the anchoring structures engaged by the attachment mechanism thereby to attach the opposing free ends of each lateral edge of the flexible belt.

In some embodiments of the seventh aspect of the invention, each anchoring structure includes a crimping-pin-hole extending through a corresponding the lateral formation in a direction orthogonal to a surface of the belt and each attachment mechanism includes a crimping pin having a diameter less than or equal to the a diameter of a the crimping-pin hole, and adapted to simultaneously engage two the crimping-pin-holes, one in each of the opposing free ends of one of the lateral edges of the belt.

In some embodiments of the seventh aspect of the invention, the flexible belt has a length within a range of 1 to 20 meters.

In some embodiments of the seventh aspect of the invention, the flexible belt has a length within a range of 5 to 20 meters.

In some embodiments of the seventh aspect of the invention, the flexible belt has a length within a range of 5 to 15 meters.

In some embodiments of the seventh aspect of the invention, the flexible belt has a length within a range of 5 to 12 meters.

In some embodiments of the seventh aspect of the invention, the flexible belt has a length within a range of 7 to 12 meters;

In some embodiments of the seventh aspect of the invention, the flexible belt has a width within a range of 0.1 to 2.0 meters.

In some embodiments of the seventh aspect of the invention, the flexible belt has a width within a range of 0.3 to 2.0 meters.

In some embodiments of the seventh aspect of the invention, the flexible belt has a width within a range of 0.5 to 2.0 meters.

In some embodiments of the seventh aspect of the invention, the flexible belt has a width within a range of 0.75 to 2.0 meters.

In some embodiments of the seventh aspect of the invention, the flexible belt has a width within a range of 0.75 to 1.5 meters.

In some embodiments of the seventh aspect of the invention, the flexible belt has a width within a range of 0.75-1.25 meters; and

In some embodiments of the seventh aspect of the invention, the flexible belt has a thickness within a range of 50 to 3000 μm.

In some embodiments of the seventh aspect of the invention, the flexible belt has a thickness within a range of 100 to 3000 mm.

In some embodiments of the seventh aspect of the invention, the flexible belt has a thickness within a range of 200 to 3000 mm.

In some embodiments of the seventh aspect of the invention, the flexible belt has a thickness within a range of 200 to 1500 mm.

In some embodiments of the seventh aspect of the invention, the flexible belt has a thickness within a range of 300 to 1000 mm.

In some embodiments of the seventh aspect of the invention, the flexible belt has a thickness within a range of 300 to 800 μm.

In some embodiments of the seventh aspect of the invention, the flexible belt has a thickness within a range of 300 to 700 μm.

In some embodiments of the seventh aspect of the invention, the flexible belt has a thickness within a range of 100 to 600 μm.

### BRIEF DESCRIPTION OF THE DRAWINGS

Some embodiments of the invention are described herein with reference to the accompanying figures. The description, together with the figures, makes apparent to a person having ordinary skill in the art how some embodiments of the invention may be practiced. The figures are for the purpose of illustrative discussion and no attempt is made to show structural details of an embodiment in more detail than is necessary for a fundamental understanding of the invention. For the sake of clarity, some objects depicted in the figures are not to scale.

In the Figures:

FIG. 1 is a schematic illustration of a printing system;

FIG. 2 is a schematic, cross section illustration of a heat-curable tape usable to connect first and second ends of an elongate belt to form an endless belt of an intermediate transfer member, in accordance with an embodiment of the present invention;

FIG. 3 shows is a schematic cross-section illustration of first and second ends of the elongate belt and the heat-curable tape positioned for curing of the heat-curable tape;

FIG. 4 shows a leading end of an elongate belt that is threaded through a printing system to form an endless belt of an intermediate transfer member;

FIG. 5 is a perspective view of one end of a support system of an intermediate transfer member of a printing system, the support system including a heater for heat-curing a seam of the intermediate transfer member, in accordance with an embodiment of the present invention;

FIG. 6 is a schematic, top view planar illustration of one embodiment of a heater forming part of the support system of FIG. 5, the heater used for curing a seam of an endless belt of the printing system;

FIG. 7 is a schematic cross-sectional illustration of the heater of FIG. 6, during operation thereof for curing the seam of FIGS. 2 and 3;

FIG. 8A is a schematic plan view showing two ends of an intermediate transfer member with lateral formations, with a detail view of several lateral formations, in accordance with an embodiment of the present invention;

FIG. 8B is a schematic elevation view of a crimping pin for securing the respective positions of the ends of the intermediate transfer member, in accordance with an embodiment of the present invention;

FIG. 8C is a schematic plan view of the several lateral formations of FIG. 8A, secured by means of the crimping pin of FIG. 8B, in accordance with an embodiment of the present invention; and

FIGS. 9 and 10 show respective flow charts of methods for installing an intermediate transfer member, in accordance with embodiments of the present invention.

### DESCRIPTION OF SOME EMBODIMENTS OF THE INVENTION

The invention, in some embodiments, relates to a heat-curable tape for connecting ends of an elongate belt to form an endless belt to be used as an intermediate transfer member suitable for use with indirect printing systems.

The invention, in some embodiments, relates to a kit for forming an intermediate transfer member to be installed in a printing system, the kit including an elongate belt and a heat-curable tape.

The invention, in some embodiments, relates to a printing system including an intermediate transfer member formed of an elongate belt and a heat-curable tape.

The invention, in some embodiments, relates to a kit for installing an intermediate transfer member in a printing system, the kit including a heat-curable tape and an adhesive.

The invention, in some embodiments, relates to a method for forming an intermediate transfer member to be installed in a printing system, the intermediate transfer member including an elongate belt and a heat-curable tape joining ends of the elongate belt at a seam.

The invention, in some embodiments, relates to a heater for heat-curing a heat-curable tape onto free ends of an elongate belt so as to form an intermediate transfer member of a printing system, and to printing systems including such a heater and methods for using thereof, and to methods of using such a heater.

The invention, in some embodiments, relates to a kit for installing an endless belt in a printing system, the kit including an elongate belt and attachment mechanisms.

The present invention is intended to solve problems arising when using prior art methods of connecting the free ends of the flexible elongate belt.

In many currently used methods, the free ends of the flexible elongate belt are connected to each other by a seam element that is condensation cured. In other words, the seam element applied onto the ends of the belt includes a polymer that hardens, or polymerizes, in a humid environment, thereby connecting the ends of the belt to form an endless belt. Due to the sensitivity of the seam element to humidity, and due to the humidity always present in the air, one can only use the seam element within 15 minutes from exposure of the polymer to the environment. Additionally, following condensation curing of the polymer in the seam element, one must wait at least an hour for the seam to have its initial strength and 24 hours are required for the seam to reach its full strength. As such, installation of an intermediate transfer member causes cessation of work of the system for at least an hour, and in some cases as long as 24 hours.

There exist some factory-formed tapes usable as seam elements, which do not require the user to apply a liquid polymer onto a substrate. Such tapes are heat-curable, but typically include epoxy, which is unsuitable for use with a silicone belt, such as the belt from which an ITM is typically formed. Other prior art tapes include a pressure sensitive adhesive, in which the curing temperature of the silicone or polymer included in the tape is not fixed, and is dependent on the pressure conditions in which the heat curing takes place.

The present invention solves the deficiencies of the prior art by providing a heat-curable adhesive tape which is not sensitive to the humidity of the environment or to the pressure during curing, and has a long shelf life and pot life. An ITM having ends connected with the tape of the present invention is strong enough to operate for at least two weeks, at a normal printing speed, without failing.

The principles, uses and implementations of the teachings herein may be better understood with reference to the accompanying description and figures. Upon perusal of the description and figures present herein, one skilled in the art is able to implement the invention without undue effort or experimentation. In the figures, like reference numerals refer to like parts throughout.

Before explaining at least one embodiment in detail, it is to be understood that the invention is not necessarily limited in its application to the details of construction and the arrangement of the components and/or methods set forth herein. The invention is capable of other embodiments or of being practiced or carried out in various ways. The phraseology and terminology employed herein are for descriptive purposes and should not be regarded as limiting.

Additional objects, features and advantages of the invention will be set forth in the detailed description which follows, and in part will be readily apparent to those skilled in the art from the description or recognized by practicing the invention as described in the written description and claims hereof, as well as the appended drawings. Various features and sub-combinations of embodiments of the invention may be employed without reference to other features and sub-combinations.

It is to be understood that both the foregoing general description and the following detailed description, including the materials, methods and examples, are merely exemplary of the invention, and are intended to provide an overview or framework to understanding the nature and character of the invention as it is claimed, and are not intended to be necessarily limiting.

In the context of the description and claims herein, the terms “seam”, “belt seam”, and “blanket seam” may be used interchangeably and relate to a material or substance used to connect first and second free ends of an elongate belt to one another, thereby to form a continuous loop, or endless belt, usable as an ITM.

In the context of the description and claims herein, the terms “blanket” and “belt” are used interchangeably and relate to a surface suitable for use as a printing surface in a printing system, such as for use as an ITM. The blanket may be an “endless blanket”, formed by connecting first and second ends of an elongate blanket to form a continuous loop.

In the context of the description and claims herein, the term “tape” relates to a stretch of a material or substance usable to connect two elements to one another.

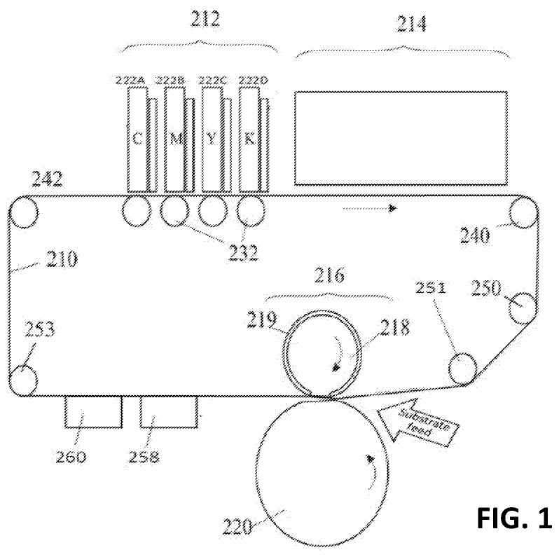

In the context of the description and claims herein, the term “heat-curable” relates to a substance or material that is cured or polymerized at a substantially fixed and elevated temperature, which is significantly higher than an ambient temperature. The curing is substantially independent of heat or humidity conditions in the environment at the time of curing. Reference is now made to FIG. 1, which is a schematic illustration of a printing system 10 that implements an indirect printing process.

The system 10 comprises an intermediate transfer member (ITM) 210 comprising a flexible endless belt mounted over a plurality of guide rollers 232, 240, 250, 251, 253, and 242.

In the specification herein, the ITM may be referred to also as an elongate belt having ends connected by a seam, as an endless belt, or as a continuous loop belt.

In some embodiments, the belt of ITM 210 has a length of up to 20 meters, and typically, a length within a range of 5-20, 5-15, 5-12, or 7-12 meters. In some embodiments, the belt of ITM 210 has a width of up to 2.0 meters, and typically, within a range of 0.3-2.0, 0.75-2.0, 0.75-1.5, or 0.75-1.25 meters.

In some embodiments, the belt of ITM 210 has a thickness of up to 3000 μm, and typically, within a range of 200-3000, 200-1500, 300-1000, 300-800, 300-700, 100-3000, 50-3000, or 100-600 μm.

In the example of FIG. 1, the ITM 210 (i.e. belt thereof) moves in the clockwise direction. The direction of belt movement defines upstream and downstream directions. Rollers 242, 240 are respectively positioned upstream and downstream of an image forming station 212—thus, roller 242 may be referred to as a “upstream roller” while roller 240 may be referred to as a “downstream roller”.

The system of FIG. 1 further includes:

(a) an image forming station 212 (e.g. comprising print bars 222A-222D, where each print bar comprises ink jet head(s)) configured to form ink images (not shown) upon a surface of the ITM 210 (e.g. by droplet deposition upon a dried treatment film).

(b) a drying station 214 for drying the ink images.

(c) an impression station 216 where the ink images are transferred from the surface of the ITM 210 to sheet or web substrate. In the particular non-limiting example of FIG. 1, impression station 216 comprises an impression cylinder 220 and a blanket cylinder 218 that carries a compressible blanket or belt 219. In some embodiments, a heater 231 may be provided shortly prior to the nip between the two cylinders 218 and 220 of the image transfer station to assist in rendering the ink film tacky, so as to facilitate transfer to the substrate (e.g. sheet substrate or web substrate). The substrate feed is illustrated schematically.

(d) a cleaning station 258 where the surface of the ITM 210 is cleaned.

(e) a treatment station 260 (i.e. in FIG. 1 illustrated schematically as a block) where a layer (e.g. of uniform thickness) of liquid treatment formulation (e.g. aqueous treatment formulation) on the ITM surface can be formed.

The skilled artisan will appreciate that not every component illustrated in FIG. 1 is required.

Exemplary descriptions of printing systems are disclosed in Applicant's PCT Publications No. WO 2013/132418 and No. WO 2017/208152 and incorporated herein by reference.

The primary purpose of the belt is to receive an ink image from the inkjet heads and to transfer that image dried but undisturbed to the substrate at the impression stations 216. Though not illustrated in the Figures, the belt forming the ITM may have multiple layers to impart desired properties to the transfer member. Specifically, the belt may include a release layer, which is an outer layer of the receiving the ink image and having suitable release properties.

Non-limiting examples of release layers and intermediate transfer members are disclosed in the Applicant's PCT Publications No. WO 2013/132432, No. WO 2013/132438 and No. WO 2017/208144, all incorporated herein by reference.

In some printing systems, the intermediate transfer member may be optionally treated at the treatment station 260 to further increase the interaction of the compatible ink with the ITM, or further facilitate the release of the dried ink image to the substrate, or provide for a desired printing effect.

Exemplary description of the treatment fluid is disclosed in Applicant's PCT Application Publication No. WO 2017/208246 and is incorporated herein by reference.

Though not shown in the figures, the substrate may be a continuous web, in which case the input and output stacks are replaced by a supply roller and a delivery roller. The substrate transport system needs to be adapted accordingly, for instance by using guide rollers and dancers taking slacks of web to properly align it with the impression station.

In the non-limiting example of FIG. 1 the printing system cannot achieve duplex printing but it is possible to provide a perfecting system to reverse substrate sheets and pass them a second time through the same nip. As a further alternative, the printing system may comprise a second impression station for transferring an ink image to opposite sides of the substrates.

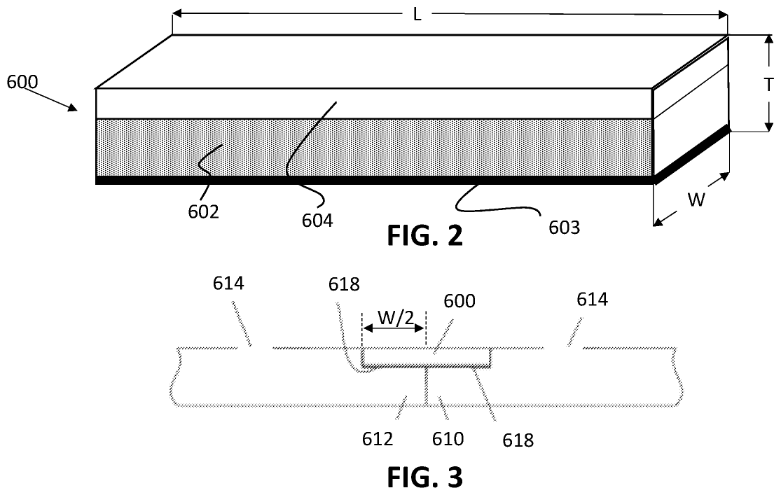

In embodiments of the present invention, the belt 210 is seamed, in that the means used to secure the free ends to one another forms a discontinuity in the transfer member. In particular, as explained in further detail hereinbelow, the ITM is formed of an initially flat elongate flexible belt having first and second free ends (before its installation in the printing system), which free ends are permanently fastened to one another using a seam, when installed within the printing system, to form a continuous loop (e.g. endless belt), as described in further detail hereinbelow with respect to FIGS. 2 and 3.

In order to assure a smooth movement and avoid a sudden change in the tension of the belt as the seam passes over the guide rollers (FIG. 1), it is desirable to make an area of the endless belt including the seam, as nearly as possible, of the same thickness as the remainder of the belt. FIG. 3, described in further detail hereinbelow, illustrates an arrangement of the flexible belt and heat-curable tape useful for ensuring that a difference in the thickness of the belt throughout the length thereof, including at an area of the seam, is not greater than 200 μm, or is in the range of 0-200 μm. Preferably, the thickness of the belt is substantially uniform throughout the belt, also in areas including the seam.

It is also desirable to avoid discontinuity of chemical and/or mechanical properties of the belt at the seam. Preferably, no ink image or part thereof is deposited on the seam, but only as close as feasible to such discontinuity on an area of the belt having substantially uniform properties/characteristics. Desirably, the seam passes impression station at a time the impression roller is not engaged with the corresponding pressure roller.

Reference is now made to FIG. 2, which is a schematic, cross section illustration of a heat-curable tape 600 usable as a seam to connect first and second free ends of an elongate belt to form the endless belt loop of intermediate transfer member 210 of FIG. 1, in accordance with an embodiment of the present invention.

As seen in FIG. 2, heat-curable tape 600 includes a substrate layer 602 and a solid silicone rubber layer 604 disposed on the substrate layer 602.

In some embodiments, the substrate layer 602 includes a fiberglass layer. In some embodiments, the substrate layer further includes a silicone coating layer 603, connected to the fiberglass layer, which may have a shore A hardness in the range of 75 to 80. In some embodiments, the substrate layer 602 has a thickness in the range of 110 μm to 170 μm.

For example, the substrate layer 602 may be a 7101 Black tape, commercially available from Taconic® of Petersburgh, N.Y., USA, which includes a fiberglass layer coated with black silicone, having a total thickness of 160 μm. However, any other suitable substrate layer may be used.

The solid silicone rubber layer 604 is connected to the substrate layer 602 by any suitable means, which may include an adhesive layer. In embodiments in which the substrate layer 602 includes a silicone coating layer 603, the solid silicone rubber layer 604 is connected to the surface of substrate layer 602 distal from silicone coating layer 603.

In some embodiments, the solid silicone rubber layer 604 includes a thermosetting polymer selected from the group of platinum catalyzed addition curing solid silicone thermosetting rubbers. In some embodiments, the solid silicone rubber of the solid silicone rubber layer 604 has a density in the range of 1.1 to 1.2 g/cm\hat{ }3, or, in some embodiments, a density of 1.15 g/cm\hat{ }3. In some embodiments, the solid silicone rubber layer 604 has a thickness in the range of 20 μm to 120 μm. In some embodiments, the solid silicone rubber layer 604 has a shore A hardness in the range of 55 to 65.

In some embodiments, the solid silicone rubber of the solid silicone rubber layer 604 has a shelf life of at least one month, at least six months, at least one year.

In some embodiments, the solid silicone rubber layer 604 is additionally or alternatively characterized in that the greater the heat quantity applied to it, the greater the strength of the heat-curable tape 600, when cured.

For example, the solid silicone rubber layer 604 may be formed of Elastosil® R plus 4066/60, commercially available from Wacker Chemie of Munich, Germany, which has been flattened to have a suitable thickness. However, any other suitable solid silicone rubber layer or addition curing polymer may be used.

An exemplary method for flattening solid silicone rubber to form the solid silicone rubber layer 604, and for connection of the solid silicone rubber layer 604 to the substrate layer 602 to form the heat-curable tape 600 is described hereinbelow with respect to Example 1.

In some embodiments, the heat-curable tape 600 has a thickness, indicated in FIG. 2 by ‘T’, in the range of 180 μm to 270 μm. In some embodiments, a ratio between the thickness of the solid silicone rubber layer 604 and the thickness of the substrate layer 602 is in the range of 0.10 to 0.75.

In some embodiments, the length of the heat curable tape 600 is greater than the width of the flexible belt used to form the ITM 210 (FIG. 1).

In some embodiments, the length of heat-curable tape 600, indicated in FIG. 2 by ‘L’, is in the range of 1200 mm to 1300 mm.

In some embodiments, the width of heat-curable tape 600, indicated in FIG. 2 by ‘W’, is in the range of 20 mm to 30 mm.

In some embodiments, a ratio between the width of heat-curable tape 600 and a length of the flexible belt used to form ITM 210 (FIG. 1) is 0.01 to 0.03.

In some embodiments, a pot life of the heat-curable tape 600 is equal to a shelf life of the solid silicone rubber of layer 604. In the context of the present application, the term “pot life” of an object, relates to the duration of time in which the object is usable, and is not harmed or changed by the environment, in normal storage conditions. In the present application, the pot life of the heat-curable tape 600 relates to the amount of time that the tape can be used without the solid silicone rubber layer 604 becoming non-tacky or “self-curing” in the environment. In some embodiments, the pot life of heat-curable tape 600 is at least one month, at least six months, or at least one year. In some embodiments, this pot-life of heat-curable tape 600 is maintained when the tape is stored in an environment having a humidity in the range of 10% to 70%.

As described hereinbelow, the heat-curable tape 600 is designed to be applied to free ends of a flexible belt so as to form an endless belt. The solid silicone rubber layer 604 is heat-cured onto the free ends of the belt, so as to form a seam connecting the free ends 610 and 612 (FIG. 3) of the belt and converting the flexible belt into an endless belt usable as ITM 210 (FIG. 1).

In some embodiments, the tape 600 is characterized in that, following heat-curing of solid silicone rubber layer 604, the tape has a tensile strength of at least 8 MPa.

In some embodiments, following heat-curing of solid silicone rubber layer 604, tape 600 has a shore A hardness of at least 45. In some embodiments, following heat-curing of solid silicone rubber layer 604, tape 600 has a shore A hardness of at most 80, following heat-curing of solid silicone rubber layer 604, tape 600 has a shore A hardness of in the range of 45 to 80.

As shown in the Examples section hereinbelow, the heat-curable tape 600 is further characterized in that, following heat-curing of solid silicone rubber layer 604 onto the flexible belt, a 20 mm segment of tape 600 is capable of resisting a load of at least 200N, at least 220N, or at least 250N, at room temperature. Under the same conditions, a 20 mm segment of tape 600 is incapable of resisting a load greater than 350N, greater than 380N, or greater than 400N, at room temperature. As such, following heat-curing of solid silicone rubber layer 604 onto the flexible belt, a 20 mm segment of tape 600 is capable of resisting a load within the range of 250N-350N, 220N-380N, or 200N-400N, at room temperature.

In some embodiments, due to the characteristics of solid silicone rubber layer 604, the greater the heat quantity applied to tape 600 for curing of the solid silicone rubber layer 604, the greater the strength of the heat-curable tape 600, when cured.

Reference is now made to FIG. 3, which shows a schematic cross-section illustration of first and second ends 610 and 612 of the elongate belt used to form ITM 210 and the heat-curable tape 600 positioned over the free ends of the belt for curing of the tape.

In prior art methods, when the free ends of the belt are joined, they are arranged to abut one another, a seam may be placed over the two ends of the flexible belt, to connect the two ends. However, this method results in an area of the belt, at which the seam is applied, having an increased thickness relative to the thickness of the rest of the belt, which may create a sudden change in the tension as this thicker area passes over the guiding rollers (FIG. 1) or through an impression station 216 (FIG. 1).

In accordance with the present invention, as illustrated in FIG. 3, application of the seam does not increase the thickness of the ITM at the area of the seam. In this embodiment, the free ends 610 and 612 of an elongate flexible belt 614 which is to be formed into the ITM 210 (FIG. 1), are ground down to form rebates 618 for receiving the heat-curable tape 600. As seen in FIG. 3, the tape 600 has a width W, and each of the rebates 618 is half as wide as the tape 600 and has a width W/2, such that when free ends 610 and 612 abut one another, rebates 618 form a channel sufficiently wide to accommodate tape 600.

The tape 600 is placed in the channel formed from rebates 618 with solid silicone rubber layer 604 facing the free ends 610 and 612, and with the substrate layer 602 being substantially flush with the upper surface of belt 614. In some embodiments, in which substrate layer 602 includes a silicone coating layer 603, the silicone coating layer is flush with the upper surface of belt 614. In some embodiments, an adhesive layer is applied onto rebates 618, and the tape 600 is applied onto the adhesive layer.

In some embodiments, the tape 600 is applied onto the rebates 618, and an adhesive layer is applied above the tape 600 and around edges thereof, so as to seal any portions of the rebates 618 not filled by the tape 600. In some embodiments, the adhesive is not applied to the release layer of belt 614. For example, the adhesive layer may comprise 3730 A&B adhesive, commercially available from Dow Corning of Midland, Mich., USA.

In some embodiments, the depth of the rebates does not exceed half the thickness of the belt 614. In some embodiments, the depth of the rebates is at least 25 μm or at least 50 μm greater than the thickness of heat-curable tape 600, so as to accommodate the tape 600 as well as the adhesive layer while a surface of tape 600 remains substantially flush with the upper surface of belt 614. In embodiments in which no adhesive layer is included, the depth of the rebates 618 may be substantially equal to the thickness of tape 600. In some embodiments, each rebate 618 has a depth in the range of 140 μm to 250 μm.

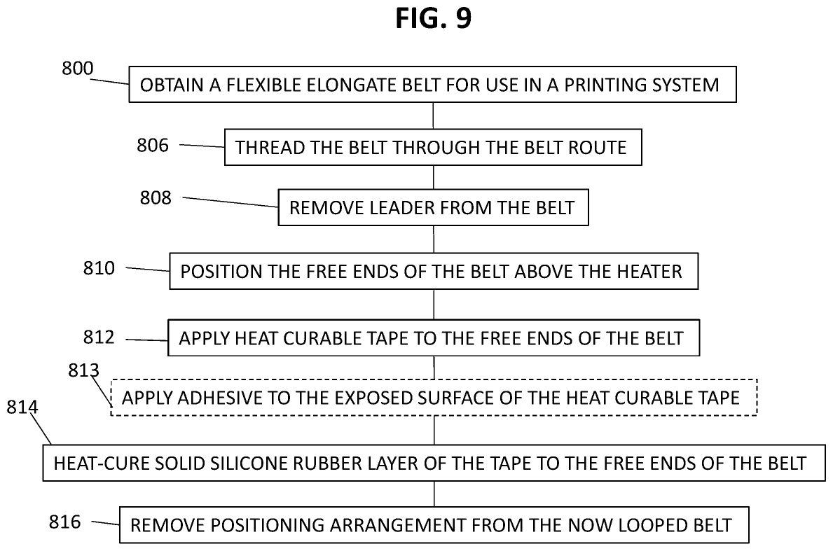

As described hereinbelow with respect to FIG. 9, the tape 600 is heat-cured onto the first and second ends 610 and 612 of belt 614. In the context of the disclosure and claims herein, an area of tape 600 or an area including tape 600 is defined as 200 mm to 250 mm of the belt which include the tape 600.

In some embodiments, the flexibility of the belt and of the tape or an area of the belt surrounding the tape may be measured by forming a loop from a rectangular strip of the area for which flexibility is being measured. The height of the loop is then measured, and is indicative of the flexibility of the material, such that the lower the height of the measured loop, the greater the flexibility.

In order to test the flexibility of a belt 614 according to the disclosure herein and of an area of the belt including tape 600, the test described above was applied a rectangular strip of the belt and/or tape area of the belt, having a width of 15 mm and a length of 150 mm.

In some embodiments, in an area of tape 600 or an area surrounding the tape, the height of the loop measuring the flexibility of the belt 614 is 2.2 cm while in other areas of the tape, not including the seam, the height of the loop measuring the flexibility of the tape is 2.0 cm. In some embodiments, a ratio between the flexibility of the belt in the area including tape 600 and the flexibility of the tape in the area not including the tape, as indicated by a ratio in the heights of the loops measured for these areas, is 0.9.

One method of measuring the stretchiness of the belt and/or of the tape is described hereinbelow with reference to Example 4. In some embodiments, in which stretchiness is measured as described herein with respect to Example 4 on a strip having a length in the range of 100 mm-200 mm and a width of 20 mm, in an area of tape 600 or an area surrounding the tape, the stretchiness of the belt 614 is in the range of 27 N/mm to 41 N/mm, while in other areas of the tape, not including the seam, the stretchiness of the tape is 24 N/mm to 37 N/mm. In some embodiments, a ratio between the stretchiness of the belt in the area including tape 600 and the stretchiness of the tape in the area not including the tape is 0.85-0.90.

In some embodiments, a variance in the thickness of belt 614, throughout the length of the belt and including the area of the belt including tape 600, is at most 200 μm.

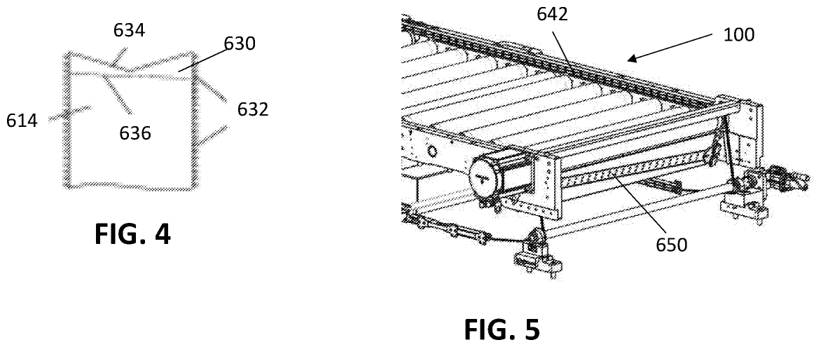

Reference is now made to FIG. 4, which shows a leader 630 of flexible elongate belt 614, as well as lateral formations 632 formed on the sides of belt 614, the leader 630 and lateral formations 632 used for threading belt 614 through a printing system, such as printing system 10 (FIG. 1) to form an endless belt of an intermediate transfer member, such as ITM 210 (FIG. 1).

As seen in FIG. 4, both belt 614 and leader 630 include lateral formations 632, formed on longitudinal ends of the belt and the leader.

The lateral formations 632 may be spaced projections, such as the teeth of one half of a zip fastener sewn or otherwise attached to each side edge of the belt 614 and of the leader 630, as shown in the embodiment of FIG. 4. Such lateral formations need not be regularly spaced.

Alternatively, the formations may be a continuous flexible bead of greater thickness than the belt 614. The lateral formations 632 may be directly attached to the edges of the belt 614 or may be attached through an intermediate strip that can optionally provide suitable elasticity to engage the formations in lateral channels of a guiding track, described and illustrated hereinbelow with reference to FIG. 5, while maintaining the belt 614 flat, in particular at the image forming station 212 (FIG. 1) of the printing system.

The lateral formations 632 may be made of any material able to sustain the operating conditions of the printing system, including the rapid motion of the ITM. Suitable materials can resist elevated temperatures in the range of about 50° C. to 250° C. Advantageously, such materials are also friction resistant and do not yield debris of size and/or amount that would negatively affect the movement of the belt during its operative lifespan. For example, the lateral formations 632 can be made of polyamide reinforced with molybdenum disulfide.

Further details on exemplary belt lateral formations according to the present invention are disclosed in PCT Publications Nos. WO 2013/136220 and WO 2013/132418. Such lateral formations and corresponding guide channels (see FIG. 5) are typically not necessary when the intermediate transfer member is mounted on a rigid support.

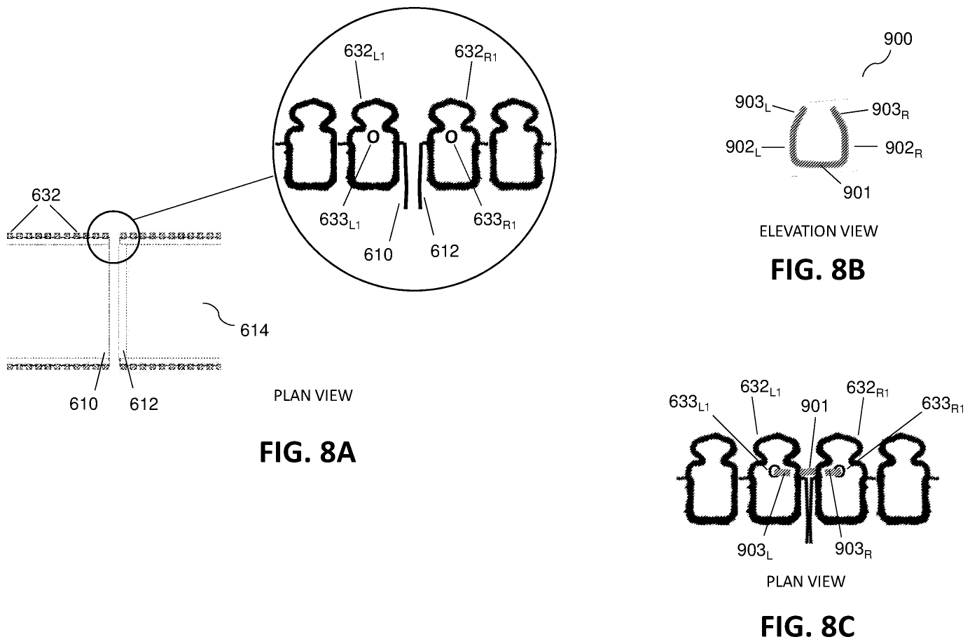

The leader 630 of the flexible belt 614 is advantageously shaped to facilitate guiding of the belt through the lateral channels of the guiding track and over the rollers during installation, for example as described hereinbelow with reference to FIGS. 5 and 8.

As illustrated in FIG. 4, the leader 630 is formed on one of ends 610 and 612 of the elongate belt forming ITM 210 (FIG. 1) which is the leading end when threading the belt through the belt route of the printing system. The leader 630 is made of a flexible material so that they may follow the belt route of the printing system, but may be made of a stiffer material than that of belt 614, so as to have less tendency to sag. The leader 630 includes a V-shaped cut-out 634 formed in the leading edge of leader 630, which cutouts help prevent sagging of the belt while it is being threaded through the belt route of the printing system.

The leader 630 may be separable from one of the ends 610 and 612 of belt 614 which forms the leading end while threading the belt. In some embodiments, the leader 630 is separably connected to one of the ends 610 and 612 by suitable links or snaps, which facilitate easy removal of the leader from the leading end of the belt once the belt is threaded through the belt route. In some embodiments, when connected to the belt 614, the leader 630 is disposed in, or above, one of rebates 618, so as to protect the rebate 618 from damage which may be caused by threading of the belt. In other embodiments, the leader 630 is connected to one of ends 610 and 612 adjacent rebate 618. In some such embodiments, the leader 630 may include corresponding rebates, and may be separable from one of ends 610 and 612 along a separation line, which is typically inclined.

As described in further detail hereinbelow, once the flexible elongate belt 614 has been pulled around the belt route of the printing system, and the leader 630 has come round to the end of the belt support system (FIG. 5), the leader 630 is removed and the opposite ends of the belt 614 are joined to one another by a seam, which may, as shown in FIG. 4, extend along an inclined line 636.

Further details on the leader according to the present invention are disclosed in PCT Publication No. WO 2016/166690 which is incorporated herein by reference.

Reference is now made to FIG. 5, which is a perspective view of one end of a belt support system 100 of an intermediate transfer member of a printing system.

The belt support system 100 further comprises a continuous lateral track defining a guiding channel 642 that can engage lateral formations 632 on the side edges of the belt, as illustrated in FIG. 4, to maintain the belt taut in its width ways direction during threading and use thereof. The guiding channel 642 may have any cross-section suitable to receive and retain the belt lateral formations 632 and maintain the belt taut.

Further details on exemplary belt lateral formations and on guide channels suitable for receiving such lateral formations, are disclosed in PCT Publication Nos. WO 2013/136220 and WO 2013/132418, which are incorporated herein by reference. Such lateral formations and corresponding guide channels are typically not necessary when the intermediate transfer member is mounted on a rigid support.

Initial guiding of the belt into position may be done for instance by securing a leader 630 (FIG. 4) attached to the leading one of ends 610 and 612 (FIG. 3) of the belt to a chain which can manually or automatically be moved to thread the belt through the belt route and install the belt. For example, an end of leader 630 of belt 614 (FIG. 4) can be releasably attached to a cable residing within each guiding channel 642. Advancing the cable(s) advances the belt along a portion of the belt route defined by the guiding channel. As discussed hereinabove with reference to FIG. 4, the leader 630 of belt 614 in the area ultimately forming the seam can have lower flexibility than in the areas other than the seam. This local “rigidity” may ease the insertion of the lateral formations 632 of the belt 614 into their respective channels.

Further details on exemplary methods for threading the belt lateral formations into the guiding channels are disclosed in PCT Publication No. WO 2016/166690.

The belt support system 100 further includes a heater for heat-curing the seam of the intermediate transfer member, in accordance with an embodiment of the present invention.

In some embodiments, such as those described hereinbelow with reference to FIG. 5, the heater 650 is adapted to have the free ends of the belt, as well as a seam tape, placed thereupon while the heater is at room temperature, and to heat up so as to apply heat to the seam tape and to heat-cure it to the free ends of the belt, thereby to form the closed loop of the ITM.

As seen in FIG. 5, the heater 650 is disposed in belt system 100 adjacent one of the rollers 240 or 242 (FIG. 1), such that when threading the elongate flexible belt, such as belt 614, through the belt route, the belt is threaded over heater 650. In some embodiments, such as that illustrated in FIG. 5, the heater 650 is disposed on a side of the belt system 100, substantially perpendicular to an upper surface 652 of a frame 654 of the belt system 100.

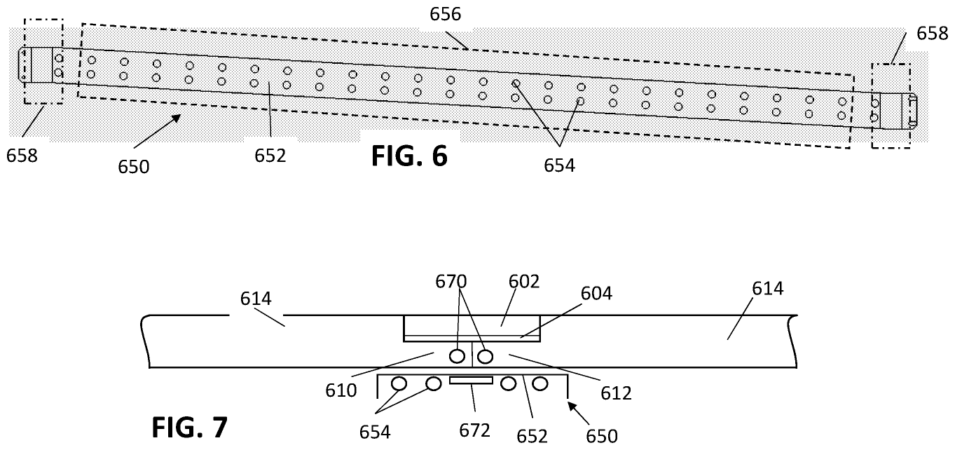

Reference is now additionally made to FIG. 6, which is a schematic, top view planar illustration of one embodiment of heater 650, and to FIG. 7, which is a schematic cross-sectional illustration of the heater 650, during operation thereof for heat-curing heat-curable tape 600 (FIG. 2) onto free ends 610 and 612 of the elongate flexible belt 614 (FIG. 3) to form a seam turning the belt 614 into the endless loop of ITM 102 (FIG. 1).

The heater 650 includes a heating surface 652, which, in operation, is disposed beneath the free ends 610 and 612 of the elongate flexible belt 614. In some embodiments, such as the embodiment illustrated in FIGS. 5 and 6, the heating surface 652 is in the shape of a parallelogram, such that the inclined line along which the free ends 610 and 612 abut one another, lies in the center of the heating surface 652. The length of the heating surface 652 is typically equal to or greater than the width of the belt 614, and the width of the heating plate 652 is sufficiently large so as to provide heat to the entire area of the seam between ends 610 and 612. In the embodiment illustrated in FIG. 7, in which the free ends 610 and 612 of the belt are connected by heat-curable tape 600, the width of the heating plate 652 is equal to or greater than the width of the heat-curable tape 600.

In some embodiments, the heater 650 or the heating surface 652 is formed of a metal selected from the group consisting of aluminum, copper, and brass. In some embodiments, the heating surface 652 has a heat conductivity in the range of 2.35 W/cmK to 40 W/cmK.

As seen clearly in FIG. 6, the heater 650 includes a plurality of heating elements 654, which, in some embodiments, are disposed beneath the heating surface 652. In some embodiments, the heating elements 654 are printed on at least one of ceramic plates, filaments, mica strips, and silicon strips.

In some embodiments, the heating elements 654 are unevenly distributed across said heating surface 652, so that a greater heat density may be provided at ends of the heating surface than at a center of the heating surface. This feature is particularly important in embodiments in which the flexible belt 614 includes lateral formations 632, as described hereinabove with respect to FIG. 4, since the belt tends to be thicker in the area of the lateral formations, and thus a greater heat density is required in order for the heat-curable tape 600, to reach a suitable temperature for heat-curing thereof in those areas.

More specifically, the heater is adapted to provide a temperature of at least 130° C. uniformly across the heat-curable tape 600, both in central areas of the tape lying above portions of the belt 614 which only include the material of the belt, and in end areas of the tape which lie above the lateral formations 632, which make the tape 600 more distant from the heating surface 652.

More specifically, the heater 650 is adapted, during operation thereof, to provide a first operative temperature in the range of 140 C to 180 C in a central region of the heating surface 652, indicated in FIG. 6 by a dashed rectangle 656, and to provide a second operative temperature in the range of 180 C to 220 C at ends of the heating surface 652, indicated by dashed rectangles 658. The heater 650 is adapted to provide such temperatures for a duration of at most one minute, at most 3 minutes, at most 5 minutes, at most 10 minutes, at most 15 minutes, or at most 20 minutes, thereby to heat-cure the tape 600. The heater 650 is adapted to reach the operative temperatures within 1 minute of activation, within 2 minutes of activation, within 3 minutes of activation, within 5 minutes of activation, or within 10 minutes of activation.

In some embodiments, illustrated clearly in FIG. 7, the flexible elongate belt 614 includes a positioning arrangement 670 removably attached to one or both of ends 610 and 612. The positioning arrangement 670 is adapted for positioning free ends 610 and 612 in abutment over heating surface 652 during heat-curing of tape 600 to the free ends of the belt. In some embodiments, the heater 650 includes a corresponding positioning arrangement 672, suitable for engaging the positioning arrangement 670 of the belt 614.

The positioning arrangement 670, and in some embodiments also the positioning arrangement 672, must be formed of a non-insulating material, so as not to hinder or interfere with heat-curing of the tape 600. In some embodiments, the positioning arrangement 670 and/or positioning arrangement 672 has a heat conductivity of at least 0.8 W/cmK.

In some embodiments, the positioning arrangement 670 of the belt includes one or more magnetic elements, such as magnetic strips removably attached to the free ends 610 and 612, and positioning arrangement 672 includes at least one magnetic element. During heat-curing of the tape 600 to the belt 614, the magnetic strips are magnetically attracted to the one or more magnets in the heater 650, such that the free ends of the belt are fixed relative to the heater 650 during operation thereof. In some such embodiments, the magnets of positioning arrangement 672 include samarium cobalt magnets. In some embodiments, the magnetic strips may be removed from the ends 610 and 612 of the belt once these ends have been connected to one another and the belt forms an endless loop.

In some embodiments, positioning arrangement 670 includes a double-sided adhesive.

In some embodiments, positioning arrangement 670 includes at least one fixing pin, and positioning arrangement 672 includes at least one correspondingly placed fixing bore, adapted to receive the at least one fixing pin during said heat-curing of tape 600.

In some embodiments, positioning arrangement 670 includes at least one elongate ridge, and positioning arrangement 672 includes at least one correspondingly placed elongate groove, adapted to receive the at least one elongate ridge during said heat-curing of tape 600.

In some embodiments, positioning arrangement 670 includes an electrostatic force generating arrangement adapted to generate electrostatic force connecting the belt 614 to heater 650.

After the tape 600 has been heat-cured to ends 610 and 612 of belt 614 to form an endless belt, a tension roller, such as roller 251 illustrated in FIG. 1, is extended to maintain the endless loop, and the intermediate transfer member, under the desired longitudinal tension.

We now refer to FIGS. 8A, 8B and 8C. In FIG. 8A, a belt 614 is shown as having two ends 610, 612 in proximity to each other in preparation for joining by a seam according to the various embodiments disclosed herein. The belt 614, as explained earlier, is characterized by having a plurality of lateral formations 632 along each of its long sides, the lateral formations 632 serving a number of functions including, inter alia, applying lateral tension to the belt 614 when residing in or moving through lateral guides provided so as to mesh with the spaced lateral formations 632.

In accordance with an embodiment of the invention, lateral formation parts 632 may include anchoring structures adapted for attachment to an attachment mechanism. For example, in the illustrated embodiment, the anchoring structures comprise crimping pin holes 633 adapted for insertion thereinto of the attachment mechanism, which may be, for example, crimping pins such as crimping pin 900 of FIG. 8B. Use of such attachment means connected to the anchoring structures, for example insertion of a crimping pin into two crimping pin holes, creates an at-least-temporary securing of the two belt ends 610, 612 to each other in advance of—and during—the applying and/or curing of a heat-curable tape. In the detail insert of FIG. 8A, lateral formations 632_{L1} (the ultimate lateral formation on belt edge 610) and 632_{R1} (the ultimate lateral formation on belt edge 612) have respective crimping pin holes 633_{L1}, 633_{R1} therethrough.

Since FIG. 8A is a plan view, it can be understood that the hole goes through the lateral formation in a direction orthogonal to the belt. Any lateral formation 632 can have a crimping pin hole, or any other anchoring structure for connection to the attachment mechanism, but in the specific non-limiting example illustrated here, only lateral formations closest to a respective end of a belt end have such crimping pin holes or anchoring structures. Crimping pin holes 633 are shown only in the lateral formations 632 of the ‘top’ lateral edge (i.e., ‘top’ when looking at the plan view drawing) of FIG. 8A. The skilled practitioner will understand that although not shown, the corresponding lateral formations 632 on the ‘bottom’ edge of the drawing, i.e., on the second lateral edge of the belt 614, also have crimping pin holes 633 in at least the first lateral formation closest to the end of each respective belt end 610, 612.

In some embodiments, anchoring structures such as crimping pin holes 633 can be provided in the lateral formations before installation, i.e., by manufacturing at least some lateral formation parts with anchoring structures or crimping pin holes already present. This may be accomplished, for example, by molding the lateral formations in that fashion or by drilling through the lateral formations after molding. Alternatively, the anchoring structures or crimping pin holes can be added later, even after a belt has left the factory, or even at the time of installing a new or replacement belt in a printing system. For example, crimping pin holes may be formed in the lateral formations by drilling through the lateral formation part in situ while preparing to apply a curable tape for long-term attachment of the two belt ends to each other, as described herein. In some embodiments, a special tool or jig can be provided to facilitate such drilling.

A non-limiting example of an attachment mechanism, and specifically of a crimping pin 900 suitable for attaching lateral formations including crimping pin holes 633, is shown schematically in FIG. 8B. According to this example, a crimping pin 900 can include a base member 901 and two upright members 902L, 902R. A crimping pin 900 can be made of any material of suitable strength and flexibility, and which is resistant to the heat curing process described above. For example, and not exhaustively, the material can include a metal or metal alloy, a polymer, or a polymer-coated or -covered metal or metal alloy. Each upright member 902 can have a respective end 903 that is partially bent away from vertical in a manner that facilitates crimping. In the context of the present application, “crimping” an end should be taken to mean bend the end over with sufficient force and precision so as to leave the end bent over to a horizontal or near-horizontal attitude.

A result of such a crimping is illustrated in FIG. 8C. In the small gap between lateral formations 632L1 and 632R1, a corresponding portion of base 901 of the crimping pin 900 can be seen—in this example the crimping pin has been inserted from underneath the lateral formations and up through the crimping pin holes 633L1, 633R1. The bent-over or crimped-over edges 903L, 903R of upright members 902L, 902R can be seen as extending upward from the respective crimping pin holes 633 and, after bending or crimping, lying across a part of the upper surface of respective lateral formations 632. The gap between the two lateral formations 632L1 and 632R1 is not shown to scale and in some embodiments the two lateral formations 632L1 and 632R1 can be touching or nearly touching after crimping.

It will be appreciated that the crimping pins and crimping pin holes described herein with respect to lateral formations 632 of belt 614 may be incorporated in any suitable lateral formations and/or belts, for example in those described in PCT publication Nos. WO 2013/136220 and WO 2013/132418 which are incorporated herein by reference.

Though the illustrated embodiments relate to anchoring structures in the form of crimping pin holes, and to attachment mechanisms in the form of crimping pins, any other form of anchoring structures and corresponding attachment mechanisms are considered to be within the scope of the present invention.

Reference is now made to FIG. 9, which shows a flow chart of a method for installing an intermediate transfer member, in accordance with an embodiment of the present invention.

Initially, a flexible elongate belt suitable for threading through a printing system, such as belt 614 (FIG. 4), is obtained at step 800.

Typically, the belt obtained at step 800 is ready for threading through the printing system, and may include a leader (630, FIG. 4), lateral formations (632, FIG. 4), a removable positioning arrangement (670, FIG. 7) and/or rebates formed at ends of the belt (618, FIG. 3).

In some embodiments, the method also includes preparing the belt for threading through the belt route of the printing system. Such preparation may include connecting a leader and/or lateral formations to the belt, connecting a removable positioning arrangement to free ends of the belt, and/or forming a rebate in each of the first and second free ends of the belt.

At step 806, the elongate flexible belt 614 is threaded through the belt route of the printing system 10 (FIG. 1). In some embodiments, this may be carried out by engaging the lateral formations 632 in the guiding channels 642 (FIG. 5) of the printing system, for guiding said flexible elongate belt along the printing system.

Once the belt 614 is threaded through the belt route, when a leader 630 is used, the leader may optionally be removed from the belt, at step 808. At step 810, the free ends 610 and 612 are positioned above the heater 650 of the printing system (FIGS. 5, 6) such that the free ends abut one another, and the rebates 618 form a channel, as illustrated in FIGS. 3 and 7. In some embodiments, positioning the free ends 610 and 612 above the heater includes engaging positioning arrangement 670 of the belt 614 to the corresponding positioning arrangement 672 (FIG. 7) of the heater 650, so that the free ends 610 and 612 are in a fixed position relative to the heater 650 and the heating surface thereof.

At step 812, the heat-curable tape 600 (FIG. 2), which includes a substrate layer and a solid silicone rubber layer, is applied to the first and second free ends 610 and 612 of the belt 614. In embodiments in which ends 610 and 612 include rebates forming a channel, the heat-curable tape 600 is placed within the channel. The heat-curable tape is placed such that the solid silicone rubber layer 604 (FIG. 2) thereof faces the surface of belt 614 or of rebates 618. In some embodiments, an adhesive layer is disposed between the tape 600 and the belt 614, and holds the tape 600 in a fixed position relative to free ends 610 and 612, until the tape is heat-cured onto the belt.

In some embodiments, following application of heat curable tape 600 to the free ends 610 and 612, an adhesive layer is applied onto the exposed surface of tape 600 at step 813. The adhesive layer may be adapted to fill any gaps between the rebates 618 and the tape 600. In some embodiments, the adhesive layer may comprise a two component adhesive, which is mixed and applied onto heat curable tape 600 prior to curing thereof. For example, the adhesive may be a 3730 A&B adhesive, commercially available from Dow Corning of Midland, Mich., USA.

Subsequently, at step 814, the solid silicone rubber layer 604 is heat-cured to the first and second free ends 610 and 612 of belt 610, so as to form a seam connecting the first and second free ends thereby converting the flexible elongate belt into an endless belt suitable for use as an ITM.

In some embodiments, heat-curing includes activating heater 650 to provide a temperature of at least 130° C. for a duration in the range of 1 to 15 minutes, following heating up of the plate of heater 650, uniformly across heat-curable tape 600. In some such embodiments, heat-curing includes activating heater 650 to provide a first operative temperature in the range of 140° C. to 180° C. at the center of the heating surface of the heater, and to provide a second operative temperature in the range of 180 C to 220 C at ends of the heating surface, where the belt is thicker due to lateral formations 632.

In some embodiments, the heater 650 is activated for a total duration of at most 5 minutes, at most 10 minutes, at most 15 minutes, at most 20 minutes, or at most 30 minutes, which total duration includes a duration in which heater 650 reaches the operational temperature and the duration of heat curing of tape 600.

In some embodiments, in which positioning arrangement 670 was removably attached to belt 614, following heat curing of tape 600, the positioning arrangement is removed from the flexible belt, which is now an endless loop, at step 816.

Following formation of the endless belt used as the ITM, the printing system may be operated at an operational temperature of 150° C. for a duration of at least two weeks without failure of the seam and without separation between the two ends of the belt. In some embodiments, such operation of the printing system includes ink-jet printing an image onto a surface of the endless belt, rotating the endless belt to move the image from a printing station 300 (FIG. 1) to an impression station 550 (FIG. 1), and, at the impression station, transferring the image from the surface of the endless belt onto a substrate.

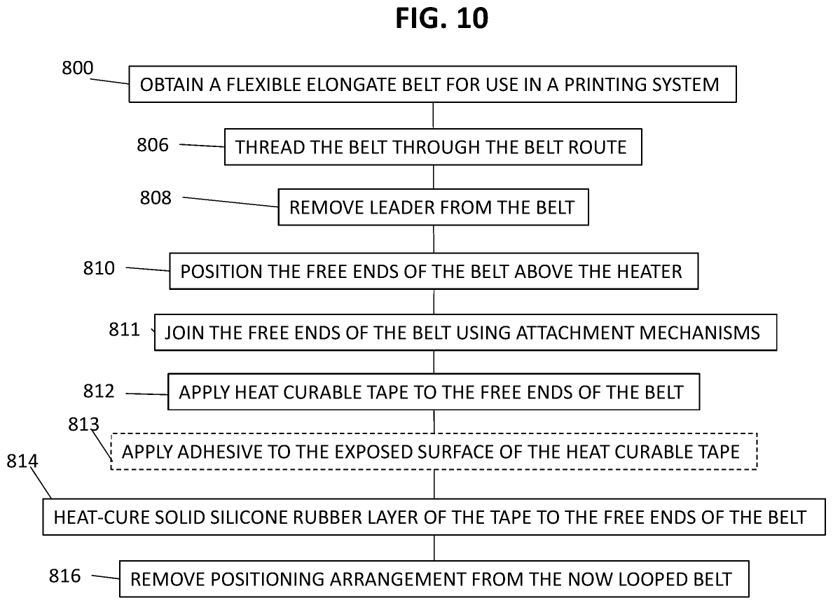

Reference is made to FIG. 10, which shows another flow chart of a method for installing an intermediate transfer member, in accordance with an embodiment of the present invention. The method of FIG. 10 is identical to the method diagrammed in the flow chart of FIG. 9, except that step 811 has been added after step 810 and before 812. Step 811 comprises the method step of at least temporarily connecting opposing free ends of the belt by use of attachment mechanisms. For example, step 811 may be accomplished using the crimping pins and crimping pin holes shown in FIGS. 8A to 8C. For example, such attachment may include the following actions:
inserting a crimping pin 900 into two respective crimping pin holes 633L1, 633R1 in two lateral formations 632L1, 632R1 which can be manually brought into proximity to each other for this purpose.
inserting an additional crimping pin 900 in respective crimping pin holes 633 of lateral formations 632 on the second lateral edge of the ends 610, 612 of the belt 614.
crimping the upper ends 903L, 903R of upright members 902L, 902R inward, for example using a crimping tool that has a strike plate, so as to securely fold down the upper ends 903L, 903R on an upward-facing part of the lateral formations 632.

Such connection of the crimping pins in the crimping pin holes creates an at-least-temporary securing of the two belt ends 610, 612 to each other before proceeding to step 812, wherein the heat-curable tape is applied to the free ends 610, 612 of the belt 614.

A crimping tool for closing the crimping pin 900 can be a separate tool, or existing elements of the printing system can be adapted or exploited for this purpose. In some embodiments, not all steps of the method are necessary.

### EXAMPLES

Reference is now made to the following examples, which together with the above description, illustrate the invention in a non-limiting fashion.

### Example 1

### Forming a Heat-Curable Tape

A substrate layer in the form of Taconic 7101 black commercially available from Taconic® of Petersburgh, N.Y., USA, which includes a fiberglass layer coated with black silicone, and has a total thickness of 160 μm, was used as the substrate layer.

A certain amount of Elsatosil® R plus 4066/60, which is a heat-curable solid silicone rubber commercially available from Wacker Chemie of Munich, Germany, was applied onto the substrate layer and then manually extruded using an extruder to form a solid silicone rubber layer.

Two substrates formed of Poly-Ethylene Terephthalate (PET), each having a thickness of 100 μm, were applied to the solid silicone rubber layer and to the black silicone coating layer of the substrate layer, and the resultant four-layer structure was flattened using Calendaring rolls until the solid silicone rubber layer had a thickness in the range of 90 μm to 100 μm. Following calendaring, the PET layer was removed from the black silicone coating layer.

The second PET layer was kept over the solid silicone rubber layer until the resulting heat-curable tape was ready for use, and was removed from the solid silicone rubber layer immediately prior to application of the tape.

The resulting tape had a total thickness of 240-250 μm, excluding the protective PET layer.

### Example 2

### Comparative Analysis of Seam Failure

The first and second ends of multiple elongate flexible belts, as described in PCT Publication No. WO 2017/208144 which is incorporated herein by reference in its entirety, were connected to each other at a seam to form an endless belt loop.

For belt #1, the ends were connected using an R4 adhesive, which is a condensation-cured adhesive tape currently used in the art. The adhesive tape was applied to the ends of the belt and cured thereto at room temperature.

For belts #2 and #3, the ends were connected using a D30 adhesive, which is an addition-cured adhesive formed of liquid silicone rubber. The adhesive was applied to the ends of the belt and cured thereto. For belt #2, curing took place at a temperature of 130° C. for a duration of 20 minutes. For belt #3, curing took place at a temperature of 150° C. for a duration of 20 minutes.

For belts #4 and #5, a heat curable tape was generated as described hereinabove in Example 1. The heat curable tape was then used to connect the ends of the belt by heat-curing of the tape. For belt #4, curing took place at a temperature of 130° C. for a duration of 20 minutes. For belt #5, curing took place at a temperature of 150° C. for a duration of 5 minutes.

Samples were taken from each of the belts, where each sample has a length of 200 mm that includes, in the center of the sample the region of the seam connecting the first and second ends of the belt, and has a width of 20 mm.

Each sample was placed in a Lloyd LS5 material tester, commercially available from Ametek® Inc. of Brewyn, Pa., USA using chantillon grips and a load cell of 1 kN. The grips held opposite ends of each sample, and the sample was pulled up with varying extension, until there was a failure in the seam, adhesive, or body of the belt.

Table 1 summarizes the conditions temperature under which each sample was tested, the load used when a failure occurred (in N/20 mm), and the type of failure.

TABLE 1

| | Testing | Maximal load | |
|---|---|---|---|
| Belt | temperature | [N/20 mm] | Failure type |
| #1 | Room temperature | 250 | Adhesion |
| #1 | 150° C. | 150 | Adhesion |
| #2 | Room temperature | 220 | Adhesion |
| #3 | Room temperature | 450 | Seam |
| #4 | Room temperature | 220 | Adhesion |
| #4 | 150° C. | 195 | Adhesion |
| #5 | Room temperature | 390 | Body |

An adhesion failure occurs when the seam or tape forming the seam disconnects from the belt, a seam failure occurs when the seam element, or tape forming the seam, tears or breaks, and a body failure occurs when the material of the belt rips due to the force applied to the sample, while the area of the seam remains intact.

As seen in Table 1, belt #4 and belt #5 whose ends were adhered using the heat-curable tape disclosed herein were able to resist a greater load than samples of the other belts, with the exception of the sample of belt #3. However, the curing conditions of that belt were at a relatively high temperature and for a relatively long duration (150 C for 20 minutes) which may have contributed to the strength of the sample. Additionally, each of the belts was able to resist a greater load when tested in room temperature than when tested at an elevated temperature.

Additionally, Table 1 shows that for belt #4 and belt #5, when tested in the same conditions, belt #5 is able to resist a much greater load. This may be due to the fact that one characteristic of the solid silicone rubber used in the heat-curable tape is that the greater the heat density provided during curing of the tape, the stronger the resulting seam.

### Example 3

### Comparative Analysis of Seam Peeling

Each of three elongate flexible belts, as described in PCT Publication No. WO 2017/208144 which is incorporated herein by reference in its entirety, was treated to include an abraded area, in which the upper coating of the belt, forming the release layer, was removed from the belt using sanding paper. Each of the three flexible belts was further treated to include a grinded area, in which a portion of the belt material was removed using a grinding machine, for example for forming rebates as described hereinabove.

Each of the belts had a seam element applied and cured to it, under standard curing conditions for that seam element, in each of three areas: an untreated portion of the release layer, termed a release area, the abraded area, and the grinded area.

For belt #1, an R4 adhesive as described hereinabove with respect to Example 2 was condensation-cured onto belt #1 at the three areas, at room temperature.

For belts #2, a D30 adhesive, as described hereinabove with respect to Example 2, was addition-cured onto belt #2 at the three areas. Curing took place at a temperature of 130° C. for a duration of 20 minutes.

For belts #3, a heat curable tape generated as described hereinabove in Example 1 was heat-cured onto the belt at the three areas. Curing took place at a temperature of 130 C for a duration of 20 minutes.

Samples were taken from each of the areas of each of the belts, where each sample has a length of 200 mm and a width of 15 mm, and includes only the seam glued to the belt without surrounding areas.

Each sample was placed in a Lloyd LS5 material tester, commercially available from Ametek® Inc. of Brewyn, Pa., USA, using TG34 grips, commercially available from Lloyd Instruments LTD of Bognor Regis, UK, and a load cell of 100N. One of the grips held part of the belt while the other grip held a portion of the seam element, and the sample was pulled to the sides with varying propagation, until the seam element was peeled off the belt. The measured peeling force is the average load of separation between the seam and the belt.

Table 2 summarizes, for each sample, the belt number, the area of the belt from which the sample was taken, and the force applied to peel the seam element off the belt.

TABLE 2

| Belt | Area | Peeling force [N] |
|---|---|---|
| #1 (R4) | Release | 0.1 |
| #1 (R4) | Grinded | 5.8 |
| #1 (R4) | Abraded | 1.8 |
| #2 (D30) | Release | 1.5 |
| #2 (D30) | Grinded | 6.5 |
| #2 (D30) | Abraded | 3.3 |
| #3 (Invention) | Release | 1.1 |
| #3 (Invention) | Grinded | 7.1 |
| #3 (Invention) | Abraded | 1.5 |

As seen in Table 2, for each of the seam elements or adhesives, the greatest peeling force was required when the seam element was applied to the grinded area, and the smallest peeling force was required when the seam element was applied to the release area.

Additionally, when comparing all the adhesives, the greatest peeling force was required when the heat-curable tape of the invention was applied to the grinded area, which is equivalent to the rebates formed in the belt as described hereinabove with respect to FIG. 4.

### Example 4

### Comparative Analysis of Stretching of the Belt Ata Seam Area and at an Area not Including the Seam

An elongate flexible belt, as described in PCT Publication No. WO 2017/208144 which is incorporated herein by reference in its entirety, was treated and seamed to form a closed loop by heat-curing a heat curable tape, generated as described hereinabove in Example 1, onto the belt. Curing took place at a temperature of 130 C for a duration of 20 minutes.

Four samples were taken from the belt, two from an area including the seam, such that the seam was at the center of the samples, and two from an area not including the seam. From each area, one sample had a length of 100 mm and another sample had a length of 200 mm, and each sample had width of 20 mm.

Each sample was placed in a Lloyd LS5 material tester, commercially available from Ametek® Inc. of Brewyn, Pa., USA, using vice grips, commercially available from Ametek® Inc. of Brewyn, Pa., USA, and a load cell of 100N. The grips held opposite ends of each sample, and the sample was pulled up and down with varying force up to 15N in each test cycle. The test included a total of 20 cycles. Following completion of the cycles, the slope of the final curve of the sample was obtained, and the spring constant of the sample was measured.

Table 3 summarizes the spring constant measured for each sample.

TABLE 3

Spring constant N/20 mm

| Sample length | 100 mm | 200 mm |
|---|---|---|
| Belt only | 41 | 27 |
| Belt with seam | 37 | 24 |

As seen in Table 3, for each of the sample lengths, the spring constant of the belt only was greater than the spring constant of the belt including the seam tape. Additionally, a ratio between the spring constant measured for the belt including the seam tape and the belt alone, for samples having the same length, is in the range of 0.88-0.91.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination or as suitable in any other described embodiment of the invention. Certain features described in the context of various embodiments are not to be considered essential features of those embodiments, unless the embodiment is inoperative without those elements.

Although the present disclosure has been described with respect to various specific embodiments presented thereof for the sake of illustration only, such specifically disclosed embodiments should not be considered limiting. Many other alternatives, modifications and variations of such embodiments will occur to those skilled in the art based upon Applicant's disclosure herein. Accordingly, it is intended to embrace all such alternatives, modifications and variations and to be bound only by the spirit and scope of the appended claims and any change which come within their meaning and range of equivalency.

In the description and claims of the present disclosure, each of the verbs “comprise”, “include” and “have”, and conjugates thereof, are used to indicate that the object or objects of the verb are not necessarily a complete listing of features, members, steps, components, elements or parts of the subject or subjects of the verb.

As used herein, the singular form “a”, “an” and “the” include plural references and mean “at least one” or “one or more” unless the context clearly dictates otherwise.

Unless otherwise stated, the use of the expression “and/or” between the last two members of a list of options for selection indicates that a selection of one or more of the listed options is appropriate and may be made.

Unless otherwise stated, adjectives such as “substantially” and “about” that modify a condition or relationship characteristic of a feature or features of an embodiment of the present technology, are to be understood to mean that the condition or characteristic is defined to within tolerances that are acceptable for operation of the embodiment for an application for which it is intended.

To the extent necessary to understand or complete the present disclosure, all publications, patents, and patent applications mentioned herein, including in particular the applications of the Applicant, are expressly incorporated by reference in their entirety as is fully set forth herein.

1. A kit for installing an endless belt in a printing system, the kit comprising:
a flexible belt having first and second free ends configured to be guided along the printing system;
a heat-curable tape, comprising a substrate layer and a solid silicone rubber layer disposed thereon,
wherein said heat-curable tape is adapted to be applied onto said first and second free ends of said flexible belt, and to be heated so as to heat-cure said solid silicone rubber layer of said tape to the first and second free ends of the flexible belt, so as to form a seam connecting the first and second free ends thereby converting the flexible belt into an endless belt.

2. The kit of claim 1, wherein said flexible belt has at least one of the following properties:
a length within a range of 1 to 20 meters, 5 to 20 meters, 5 to 15 meters, 5 to 12 meters, or 7 to 12 meters;
a width within a range of 0.1 to 2.0 meters, 0.3 to 2.0 meters, 0.5 to 2.0 meters, 0.75 to 2.0 meters, 0.75 to 1.5 meters, or 0.75-1.25 meters; and
a thickness within a range of 50 to 3000 μm, 100 to 3000 μm, 200 to 3000 μm, 200 to 1500 μm, 300 to 1000 μm, 300 to 800 μm, 300 to 700 μm, or 100 to 600 μm.

3. The kit of claim 1 or claim 2, wherein, following heat-curing of said solid silicone rubber layer of said heat curable tape, the following properties are true:
said tape has a tensile strength of at least 8 MPa;
said tape has a shore A hardness of at least 45; and
a strength of said heat curable tape is directly proportional to a heat quantity applied to said solid silicone rubber layer during curing of said tape.

4. The kit of any one of claim 1 or claim 2, wherein, following heat-curing of said solid silicone rubber layer of said heat curable tape, at least one of the following properties is true:
said tape has a tensile strength of at least 8 MPa;
said tape has a shore A hardness of at least 45;
said tape has a shore A hardness in the range of 45 to 80;
a strength of said heat curable tape is directly proportional to a heat quantity applied to said solid silicone rubber layer during curing of said tape;
a 20 mm segment of said endless belt, including said heat-cured tape, is capable of resisting a load of at least 200N, at least 220N, or at least 250N, at room temperature; and
a 20 mm segment of said endless belt, including said heat-cured tape, is incapable of resisting a load greater than 350N, greater than 380N, or greater than 400N, at room temperature.

5. The kit of any one of claims 1 to 4, wherein said solid silicone rubber has a shelf life of at least one month, at least six months, at least one year.

6. The kit of any one of claims 1 to 5, wherein a pot life of said heat curable tape is at least one of:
equal to a shelf life of said solid silicone rubber; and
at least one month, at least six months, or at least one year.

7. The kit of any one of claims 1 to 6, wherein said solid silicone rubber comprises a thermosetting polymer.

8. The kit of any one of claims 1 to 7, wherein said solid silicone rubber has a density in the range of 1.1 to 1.2 g/cm\hat{ }3, or a density of 1.15 g/cm\hat{ }3.

9. The kit of any one of claims 1 to 8, wherein said substrate layer includes a fiberglass layer.

10. The kit of claim 9, wherein said substrate layer further includes a silicone coating layer, connected to said fiberglass layer.

11. The kit of claim 10, wherein said silicone coating layer has a shore A hardness in the range of 75 to 80.

12. The kit of any one of claims 1 to 11, wherein said substrate layer has a thickness in the range of 110 μm to 170 μm.

13. The kit of any one of claims 1 to 12, wherein said solid silicone rubber layer has a thickness in the range of 20 μm to 120 μm.

14. The kit of any one of claims 1 to 13, wherein a ratio between a thickness of said solid silicone rubber layer and a thickness of said substrate layer is in the range of 0.10 to 0.75.

15. The kit of any one of claims 1 to 14, wherein said curable tape has a thickness in the range of 180 μm to 270 μm.

16. The kit of any one of claims 1 to 15, wherein a ratio between a thickness of said tape and a thickness of said belt is in the range of 0.15 to 11.15.

17. The kit of any one of claims 1 to 16, wherein a length of said heat curable tape is greater than a width of said flexible belt.

18. The kit of any one of claims 1 to 17, wherein a ratio between a width of said tape and a length of said belt is in the range of 0.01 to 0.03.

19. The kit of any one of claims 1 to 18, further comprising a heater adapted to be disposed beneath said heat curable tape when said heat curable tape is applied to said first and second ends of said flexible belt, and adapted to provide heat sufficient for heat-curing said solid silicone rubber of said heat-curable tape thereby to heat-cure said heat curable tape to form said endless belt.

20. The kit of claim 19, wherein said heater includes a heating surface having a width greater than a width of said heat-cured tape.

21. The kit of claim 20, wherein the heater is designed such that a greater heat density is provided at ends of said heating surface than at a center of said heating surface.

22. The kit of claim 20, wherein the heater includes a plurality of heating elements, said heating elements being unevenly distributed across said heating surface, such that a greater heat density is provided at ends of said heating surface than at a center of said heating surface.

23. The kit of any one of claims 20 to 22, wherein said heater is adapted, during operation thereof, to provide a first operative temperature at said center of said heating surface, and to provide a second operative temperature at said ends of said heating surface.

24. The kit of any one of claims 20 to 23, wherein said heater is adapted, during operation thereof when said first and second ends of said flexible elongate belt are disposed over said heating surface, and said heat-curable tape is disposed over said first and second ends, to provide a uniform temperature across said heat-curable tape.

25. The kit of any one of claims 23 to 24, wherein, during operation of said heater, when said first and second ends of said flexible elongate belt are disposed over said heating surface, and said heat-curable tape is disposed over said first and second ends, said heater is adapted to provide said first and said second operative temperatures for a duration of at most 1 minute, at most 3 minutes, at most 5 minutes, at most 10 minutes, at most 15 minutes, or at most 20 minutes, thereby to heat-cure said solid silicone rubber of said heat-curable tape.

26. The kit of any one of claims 20 to 25, wherein said flexible elongate belt has a positioning arrangement removably attached to said first and second ends, said positioning arrangement adapted for positioning said first and second ends of said belt over said heating surface of said heater during heat-curing of said heat-curable tape.

27. The kit of claim 26, wherein said positioning arrangement includes at least one magnetic element, and said heater includes at least one corresponding magnetic element adapted to magnetically attract said at least one magnetic element of said positioning arrangement during said heat-curing of said heat-curable tape.

28. The kit of claim 27, wherein said at least one magnetic element comprises a magnetic metal strip removably attached to each of said first and second ends of said flexible elongate belt.

29. The kit of any one of claims 1 to 28, wherein said flexible belt includes a rebate at each of said first and second ends, wherein when said rebates are positioned adjacent one another a channel is formed, said channel sized and adapted to accommodate said heat curable tape therein.

30. The kit of claim 29, wherein each said rebate has a depth in the range of 140 μm to 250 μm.

31. The kit of any one of claims 1 to 30, wherein:
(i) the flexible belt includes a plurality of lateral formations along at least a portion of each lateral edge, and
(ii) at least one of the lateral formations on each lateral edge at each one of the free ends of the flexible belt includes an anchoring structure adapted for attachment to an attachment mechanism, which attachment mechanism is adapted for attaching ones of said laterally extending formations at opposing free ends of each lateral edge of the flexible belt.

32. The kit of claim 31, additionally including at least two attachment mechanisms each adapted to engage at least two said anchoring structures at opposing free ends of each lateral edge of said belt and to attach the laterally extending formations associated with said anchoring structures engaged by said attachment mechanism thereby to attach said opposing free ends of each lateral edge of the flexible belt.

33. The kit of claim 32, wherein each said anchoring structure comprises a crimping-pin-hole extending through a corresponding said lateral formation in a direction orthogonal to a surface of the belt and each said attachment mechanism comprises a crimping pin having a diameter less than or equal to the diameter of a said crimping-pin hole, and adapted to simultaneously engage two said crimping-pin-holes, one in each of said opposing free ends of one of the lateral edges of the belt.

34. A printing system comprising:
an intermediate transfer member (ITM) comprising an endless belt, said endless belt comprising:
(i) heat-curable tape comprising a substrate layer and a solid silicone rubber layer disposed thereon, and
(ii) a flexible elongate belt having first and second ends, said first and second ends connected at a seam by said heat-curable tape;
an image forming station at which droplets of an ink are applied to an outer surface of said intermediate transfer member to form an ink image;
a drying station for drying the ink image to leave an ink residue film; and
an impression station at which the residue film is transferred to a sheet or web substrate sheet.

35. The printing system of claim 34, wherein said flexible belt has at least one of the following properties:
a length within a range of 1 to 20 meters, 5 to 20 meters, 5 to 15 meters, 5 to 12 meters, or 7 to 12 meters;
a width within a range of 0.1 to 2.0 meters, 0.3 to 2.0 meters, 0.5 to 2.0 meters, 0.75 to 2.0 meters, 0.75 to 1.5 meters, or 0.75-1.25 meters; and
a thickness within a range of 50 to 3000 μm, 100 to 3000 μm, 200 to 3000 μm, 200 to 1500 μm, 300 to 1000 μm, 300 to 800 μm, 300 to 700 μm, or 100 to 600 μm.

36. The printing system of claim 34 or claim 35, wherein, following heat-curing of said solid silicone rubber layer of said heat curable tape, the following properties are true:
said tape has a tensile strength of at least 8 MPa;
said tape has a shore A hardness of at least 45; and
a strength of said heat curable tape is directly proportional to a heat quantity applied to said solid silicone rubber layer during curing of said tape.

37. The printing system of claim 34 or claim 35, wherein, following heat-curing of said solid silicone rubber layer of said heat-curable tape, at least one of the following properties is true:
said heat-curable tape has a tensile strength of at least 8 MPa;
said heat-curable tape has a shore A hardness of at least 45;
said heat-curable tape has a shore A hardness in the range of 45 to 80;
a strength of said heat curable tape is directly proportional to a heat quantity applied to said solid silicone rubber layer during curing of said tape;
a 20 mm segment of said endless belt, including said heat-cured tape, is capable of resisting a load of at least 200N, at least 220N, or at least 250N, at room temperature; and
a 20 mm segment of said endless belt, including said heat-cured tape, is incapable of resisting a load greater than 350N, greater than 380N, or greater than 400N, at room temperature.

38. The printing system of any one of claims 34 to 37, wherein said solid silicone rubber has a shelf life of at least one month, at least six months, at least one year.

39. The printing system of any one of claims 34 to 38, wherein a pot life of said heat curable tape is at least one of:
equal to a shelf life of said solid silicone rubber; and
at least one month, at least six months, or at least one year.

40. The printing system of any one of claims 34 to 39, wherein said solid silicone rubber comprises a thermosetting polymer.

41. The printing system of any one of claims 34 to 40, wherein said solid silicone rubber has a density in the range of 1.1 to 1.2 g/cm\hat{ }3, or a density of 1.15 g/cm\hat{ }3.

42. The printing system of any one of claims 34 to 41, wherein said substrate layer includes a fiberglass layer.

43. The printing system of claim 42, wherein said substrate layer further includes a silicone coating layer, connected to said fiberglass layer.

44. The printing system of claim 43, wherein said silicone coating layer has a shore A hardness in the range of 75 to 80.

45. The printing system of any one of claims 34 to 44, wherein said substrate layer has a thickness in the range of 110 μm to 170 μm.

46. The printing system of any one of claims 34 to 45, wherein said solid silicone rubber layer has a thickness in the range of 20 μm to 120 μm.

47. The printing system of any one of claims 34 to 46, wherein a ratio between a thickness of said solid silicone rubber layer and a thickness of said substrate layer is in the range of 0.10 to 0.75.

48. The printing system of any one of claims 34 to 47, wherein said heat-curable tape has a thickness in the range of 180 μm to 270 μm.

49. The printing system of any one of claims 34 to 48, wherein a ratio between a thickness of said tape and a thickness of said belt is in the range of 0.15 to 11.15.

50. The printing system of any one of claims 34 to 49, wherein a length of said heat-curable tape is greater than a width of said flexible belt.

51. The printing system of any one of claims 34 to 50, wherein a ratio between a width of said tape and a length of said belt is in the range of 0.01 to 0.03.

52. The printing system of any one of claims 34 to 51, wherein said intermediate transfer member is used for indirect ink-jet printing in the printing system at an operational temperature in the range of 130 C to 170 C for a duration of at least two weeks without failure of said seam.

53. The printing system of any one of claims 34 to 52, wherein said flexible elongate belt includes a rebate at each of said first and second ends, wherein, in said endless belt, said heat curable tape is accommodated in a channel formed by said rebates being positioned adjacent one another.

54. The printing system of claim 53, wherein each said rebate has a depth in the range of 140 μm to 250 μm.

55. The printing system of any one of claims 34 to 54, further comprising a heater disposed beneath said intermediate transfer member and adapted to provide heat sufficient for heat-curing said solid silicone rubber of said heat-curable tape thereby to heat-cure said heat curable tape onto said first and second ends to form said endless belt.

56. The printing system of claim 55, said heater including a heating surface having a width greater than a width of said heat-cured tape.

57. The printing system of claim 55 or claim 56, wherein said heater forms part of a belt support system of the printing system, and is mounted adjacent rollers adapted to guide said endless belt during operation of the printing system.

58. The printing system of any one of claims 56 to 57, wherein the heater is designed such that a greater heat density is provided at ends of said heating surface than at a center of said heating surface.

59. The printing system of any one of claims 56 to 58 wherein the heater includes a plurality of heating elements, said heating elements being unevenly distributed across said heating surface, such that a greater heat density is provided at ends of said heating surface than at a center of said heating surface.

60. The printing system of any one of claims 58 to 59, wherein said heater is adapted, during operation thereof, to provide a first operative temperature at said center of said heating surface, and to provide a second operative temperature at said ends of said heating surface.

61. The printing system of any one of claims 56 to 60, wherein said heater is adapted, during operation thereof when said first and second ends of said flexible elongate belt are disposed over said heating surface, and said heat-curable tape is disposed over said first and second ends, to provide a uniform temperature across said heat-curable tape.

62. The printing system of any one of claims 60 to 61, wherein, during operation of said heater, when said first and second ends of said flexible elongate belt are disposed over said heating surface, and said heat-curable tape is disposed over said first and second ends, said heater is adapted to provide said first and said second operative temperatures for a duration of at most 1 minute, at most 3 minutes, at most 5 minutes, at most 10 minutes, at most 15 minutes, or at most 20 minutes, thereby to heat-cure said solid silicone rubber of said heat-curable tape.

63. The printing system of any one of claims 55 to 62, wherein said flexible elongate belt has a positioning arrangement removably attached to said first and second ends, said positioning arrangement adapted for positioning said first and second ends of said belt over said heating surface of said heater during heat-curing of said heat-curable tape.

64. The printing system of claim 63, wherein said positioning arrangement includes at least one magnetic element, and said heater includes at least one corresponding magnetic element adapted to magnetically attract said at least one magnetic element of said positioning arrangement during said heat-curing of said heat-curable tape.

65. The printing system of claim 64, wherein said at least one magnetic element comprises a magnetic metal strip removably attached to each of said first and second ends of said flexible elongate belt.

66. The printing system of any one of claims 34 to 65, wherein:
(i) the flexible elongate belt includes a plurality of lateral formations along at least a portion of each lateral edge,
(ii) at least one of the lateral formations on each lateral edge at each one of the free ends of the flexible belt includes an anchoring structure adapted for attachment to an attachment mechanism; and
(iii) said system further includes at least two attachment mechanisms each engaging at least two said anchoring structures at opposing free ends of one said lateral edges of said belt and attach the laterally extending formations associated with said at least two anchoring structures, thereby attaching said opposing free ends of each said lateral edge of the flexible belt.

67. The printing system of claim 66, wherein:
each said anchoring structure comprises a crimping-pin-hole extending through a corresponding said lateral formation in a direction orthogonal to a surface of the belt; and
each said attachment mechanism comprises a crimping pin having a diameter less than or equal to a diameter of said crimping-pin holes, simultaneously engaging two said crimping-pin-holes, one in each of said opposing free ends of one of the lateral edges of the belt.

68. A method of forming an endless belt from a flexible belt having first and second free ends the method comprising:
when the flexible belt is threaded through a belt route of a printing system such that the first and second free ends are positioned over a heater disposed in the printing system, performing the following:
(i) applying a heat-curable tape, comprising a substrate layer and a solid silicone rubber layer disposed thereon, or respective portions thereof, over the first and second free ends of the flexible belt; and
(ii) heat-curing said solid silicone rubber layer of said heat-curable tape to the first and second free ends of the flexible belt, so as to form a seam connecting the first and second free ends thereby converting the flexible belt into an endless belt.

69. The method of claim 68, said flexible belt including lateral formations along sides thereof, said method further comprising threading said flexible belt through the belt route by engaging said formations with lateral tracks of the printing system for guiding said flexible belt along the printing system.

70. The method of claim 68 or claim 69, further comprising providing said heater beneath said intermediate transfer member, and wherein said heat-curing comprises operating said heater to provide heat sufficient for said heat-curing.

71. The method of any one of claims 68 to 70, further comprising, following said applying said heat-curable tape and prior to said heat-curing, applying an adhesive onto an exposed surface of said heat-curable tape.

72. A method of forming an endless belt from a flexible belt having first and second free ends the method comprising:
providing a heat-curable tape, comprising a substrate layer and a solid silicone rubber layer disposed thereon, or respective portions thereof;
providing a heater adapted to provide heat sufficient for heat-curing said solid silicone rubber layer;
threading the flexible belt through a belt route of a printing system to position the first and second free ends over said heater;
applying said heat-curable tape over the first and second free ends of the flexible belt; and
using said heater, heat-curing said solid silicone rubber layer of said heat-curable tape to the first and second free ends of the flexible belt, so as to form a seam connecting the first and second free ends thereby forming an endless belt from the flexible belt.

73. The method of claim 72, further comprising, following said applying said heat-curable tape and prior to said heat-curing, applying an adhesive onto an exposed surface of said heat-curable tape.

74. The method of any one of claims 68 to 73, wherein, following said heat-curing of said solid silicone rubber layer of said heat curable tape, the following properties are true:
said tape has a tensile strength of at least 8 MPa;
said tape has a shore A hardness of at least 45; and
a strength of said heat curable tape is directly proportional to a heat quantity applied to said solid silicone rubber layer during curing of said tape.

75. The method of any one of claims 68 to 73, wherein, following said heat-curing, at least one of the following properties is true:
said tape has a tensile strength of at least 8 MPa;
said tape has a shore A hardness of at least 45;
said tape has a shore A hardness in the range of 45 to 80;
a strength of said heat curable tape is directly proportional to a heat quantity applied to said solid silicone rubber layer during curing of said tape;
a 20 mm segment of said endless belt including said tape is capable of resisting a load of at least 200N, at least 220N, or at least 250N, at room temperature; and
a 20 mm segment of said endless belt including said tape is incapable of resisting a load greater than 350N, greater than 380N, or greater than 400N, at room temperature.

76. The method of any one of claims 68 to 75, wherein said heater includes a heating surface having a width greater than a width of said heat-curable tape.

77. The method of any one of claims 68 to 76, wherein said heat-curing comprises activating the heater to provide a temperature of at least 130 C for a duration of at most 1 minute, at most 3 minutes, at most 5 minutes, at most 10 minutes, at most 15 minutes, or at most 20 minutes uniformly across said heat-curable tape.

78. The method of claim 76 or claim 77, wherein said heat-curing comprises activating the heater to provide a greater heat density at ends of said heating surface than at a center of said heating surface.

79. The method of any one of claims 76 to 78, wherein said heat-curing comprises activating said heater to provide a first operative temperature at a center of a heating surface of the heater, and to provide a second operative temperature at ends of the heating surface of the heater.

80. The method of claim 79, wherein said activating said heater comprises activating said heater to provide said first and said second operative temperatures for a duration of at most 1 minute, at most 3 minutes, at most 5 minutes, at most 10 minutes, at most 15 minutes, or at most 20 minutes, thereby to heat-cure said solid silicone rubber of said heat-curable tape.

81. The method of any one of claims 79 to 80, wherein said activating said heater comprises activating said heater such that a temperature of a heating surface of said heater reaches said first and second operative temperatures within a duration of at most 1 minute, at most 3 minutes, at most 5 minutes, or at most 10 minutes.

82. The method of any one of claims 69 to 81, further comprising:
prior to said threading of said flexible belt through said belt route, attaching a positioning arrangement to said first and second free ends; and
prior to said applying said heat-curable tape, using said positioning arrangement, positioning said first and second free ends in a fixed position relative to the heater.

83. The method of claim 82, further comprising, following said heat-curing, removing said positioning arrangement from said flexible belt.

84. The method of any one of claims 82 to 83, wherein said positioning arrangement includes at least one magnetic element, and wherein said positioning comprises magnetically engaging said at least one magnetic element to at least one corresponding magnetic element of the heater.

85. The method of any one of claims 69 to 84, further comprising:
prior to said threading of said flexible belt through said belt route, forming a rebate at each of said first and second free ends of said flexible belt; and
following threading of said flexible belt through said belt route, positioning said rebates adjacent one another to form a channel,
wherein said applying said heat-curable tape comprises accommodating said heat-curable tape in said channel.

86. The method of claim 85, wherein said forming a rebate comprises forming a rebate having a depth in the range of 140 μm to 250 μm.

87. The method of any one of claims 68 to 86, further comprising, following said heat-curing, operating said endless belt in said printing system at an operational temperature of 150 C for a duration of at least two weeks without failure of said seam.

88. The method of any one of claims 72 to 87, the flexible belt comprising a plurality of lateral formations along at least a portion of each lateral edge, wherein at least one of the lateral formations on each lateral edge at each one of the free ends of the flexible belt includes an anchoring structure adapted for attachment to an attachment mechanism, the method additionally comprising the step of:
connecting at least one said attachment mechanism to anchoring structures associated with the lateral formations of each of the respective first and second free ends of each lateral side of the belt, so as to attach the first and second free ends of the belt to each other.

89. The method of any one of claim 88, wherein each said anchoring structure comprises a crimping-pin-hole extending through said lateral formation in a direction orthogonal to a surface of the belt and each said attachment mechanism comprises a crimping pin including a pair of upright members, wherein said connecting comprises:
a. inserting two crimping pins, one crimping pin for each lateral edge of the belt, through respective pairs of crimping-pin-holes in the ultimate lateral formations of each of the respective first and second free ends of the belt, so as to hold the first and second free ends of the belt in proximity to each other, and
b. crimping ends of the upright members of each of the crimping pins.

90. A method of printing an image onto a substrate in a printing system including a printing station and an impression station, the method comprising:
in the printing system, forming an endless belt according to the method of any one of claims 68 to 89;
ink-jet printing an image onto a surface of said endless belt;
rotating said endless belt to move said image from the printing station to the impression station; and
transferring said image from said surface of said endless belt onto the substrate.

91. A printing system comprising:
an intermediate transfer member (ITM) comprising an endless belt, said endless belt comprising a flexible elongate belt having first and second ends, said first and second ends connected by a seam;
a heater disposed beneath said intermediate transfer member and adapted to provide heat sufficient for attaching said seam to said first and second ends;
an image forming station at which droplets of an ink are applied to an outer surface of said intermediate transfer member to form an ink image;
a drying station for drying the ink image to leave an ink residue film; and
an impression station at which the residue film is transferred to a sheet or web substrate sheet.

92. The printing system of claim 91, wherein said seam includes a heat curable adhesive and wherein said heater is adapted to provide heat sufficient for heat-curing the heat-curable adhesive of said seam.

93. The printing system of claim 91 or claim 92, said heater including a heating surface having a width greater than a width of said seam.

94. The printing system of any one of claims 91 to 93, wherein said heater forms part of a belt support system of the printing system, and is mounted adjacent rollers adapted to guide said endless belt during operation of the printing system.

95. The printing system of any one of claims 93 to 94, wherein the heater is designed such that a greater heat density is provided at ends of said heating surface than at a center of said heating surface.

96. The printing system of any one of claims 93 to 95, wherein said heater includes a plurality of heating elements, said heating elements being unevenly distributed across said heating surface, such that a greater heat density is provided at ends of said heating surface than at a center of said heating surface.

97. The printing system of any one of claims 95 to 96, wherein said heater is adapted, during operation thereof, to provide a first operative temperature at said center of said heating surface, and to provide a second operative temperature at said ends of said heating surface.

98. The printing system of claim 97, wherein, during operation of said heater, when said first and second ends of said flexible elongate belt are disposed over said heating surface, and said seam is disposed over said first and second ends, said heater is adapted to provide said first and said second operative temperatures for a duration of at most 1 minute, at most 3 minutes, at most 5 minutes, at most 10 minutes, at most 15 minutes, or at most 20 minutes, thereby to heat-cure said seam.

99. The printing system of any one of claims 97 to 98, wherein said heater is adapted to reach said first and second operative temperatures within a duration of at most 1 minute, at most 3 minutes, at most 5 minutes, or at most 10 minutes.

100. The printing system of any one of claims 93 to 99, wherein said heater is adapted, during operation thereof when said first and second ends of said flexible elongate belt are disposed over said heating surface, and said seam is disposed over said first and second ends, to provide a uniform temperature across said seam.

101. The printing system of any one of claims 91 to 100, wherein said flexible belt has at least one of the following properties:
a length within a range of 1 to 20 meters, 5 to 20 meters, 5 to 15 meters, 5 to 12 meters, or 7 to 12 meters;
a width with a range of 0.1 to 2.0 meters, 0.3 to 2.0 meters, 0.5 to 2.0 meters, 0.75 to 2.0 meters, 0.75 to 1.5 meters, or 0.75 to 1.25 meters; and
a thickness within a range of 50 to 3000 μm, 100 to 3000 μm, 200 to 3000 μm, 200 to 1500 μm, 300 to 1000 μm, 300 to 800 μm, 300 to 700 μm, or 100 to 600 μm.

102. The printing system of any one of claims 91 to 101, wherein said intermediate transfer member is used for indirect ink-jet printing in the printing system at an operational temperature in the range of 130 C to 170 C for a duration of at least two weeks without failure of said seam.

103. The printing system of any one of claims 91 to 102, wherein said flexible elongate belt has a positioning arrangement removably attached to said first and second ends, said positioning arrangement adapted for positioning said first and second ends of said flexible belt over said heater during heat-curing of said heat-curable adhesive.

104. The printing system of claim 103, wherein said positioning arrangement includes at least one magnetic element, and said heater includes at least one corresponding magnetic element adapted to magnetically attract said at least one magnetic element of said positioning arrangement during said heat-curing of said heat-curable adhesive.

105. The printing system of claim 104, wherein said at least one magnetic element comprises a magnetic metal strip removably attached to each of said first and second ends of said flexible elongate belt.

106. The printing system of any one of claims 91 to 105, wherein:
(i) the flexible elongate belt includes a plurality of lateral formations along at least a portion of each lateral edge,
(ii) at least one of the lateral formations on each lateral edge at each one of the free ends of the flexible belt including an anchoring structure; and
(iii) at least two attachment mechanisms each engaging at least two said anchoring structures associated with laterally extending formations at each one of the opposing free ends of a lateral edge of the belt and attaching the laterally extending formations associated with said at least two said anchoring structures to each other, thereby attaching said opposing free ends on each lateral edge of the flexible belt.

107. The printing system of claim 106, wherein said anchoring structure comprises a crimping-pin-hole extending through said lateral formation in a direction orthogonal to a surface of the belt and each said attachment mechanism comprises a crimping pin having a diameter less than or equal to the diameters of said crimping-pin holes, simultaneously engaging two said crimping-pin-holes, one in each of said free ends of one of the lateral edges of the belt.

108. A method of forming said endless belt of the printing system of any one of claims 91 to 107, the method comprising:
threading said flexible elongate belt through a belt route of said printing system, such that said first and second ends of said flexible elongate belt are placed adjacent one another over said heater;
applying said seam over the first and second free ends of the flexible belt; and
using said heater, attaching said seam to the first and second free ends of the flexible belt, so as to connect the first and second free ends thereby converting the flexible belt into an endless belt.

109. A method of forming said endless belt of the printing system of any one of claims 103 to 107, the method comprising:
attaching said positioning arrangement to said first and second free ends of said flexible belt;
threading said flexible elongate belt through a belt route of said printing system, such that said first and second ends of said flexible elongate belt are placed adjacent one another over said heater;
using said positioning arrangement, positioning said first and second free ends in a fixed position relative to the heater;
applying said seam over the first and second free ends of the flexible belt; and
using said heater, attaching said seam to the first and second free ends of the flexible belt, so as to connect the first and second free ends thereby converting the flexible belt into an endless belt.

110. The method of claim 109, further comprising, following said attaching, removing said positioning arrangement from said flexible belt.

111. The method of any one of claims 108 to 110, further comprising:
prior to threading of said flexible belt through said belt route, forming a rebate at each of said first and second free ends of said flexible belt; and
following threading of said flexible belt through said belt route, positioning said rebates adjacent one another to form a channel,
wherein said applying said seam comprises placing said seam in said channel.

112. The method of claim 111, wherein said forming a rebate comprises forming a rebate having a depth in the range of 140 μm to 250 μm.

113. The method of any one of claims 108 to 112, wherein said attaching comprises operating said heater to provide a greater heat density at ends of said heater than at a center of said heater.

114. The method of any one of claims 108 to 113, wherein said attaching comprises operating the heater to provide a first operative temperature at a center of said heater, and to provide a second operative temperature at ends of said heater.

115. The method of any one of claims 108 to 114, the flexible belt comprising a plurality of lateral formations along at least a portion of each lateral edge thereof, wherein at least one of the lateral formations on each lateral edge at each one of the free ends of the flexible belt includes an anchoring structure for a attachment mechanism, the method additionally comprising the step of:
connecting at least one said attachment mechanism to anchoring structures associated with the lateral formations of each of the respective first and second free ends of each lateral side of the belt, so as to attach the first and second free ends of the belt to each other.

116. The method of any one of claim 115, wherein each said anchoring structure comprises a crimping-pin-hole extending through said lateral formation in a direction orthogonal to a surface of the belt and each said attachment mechanism comprises a crimping pin including a pair of upright members, wherein said connecting comprises:
a. inserting two crimping pins, one crimping pin for each lateral edge of the belt, through respective pairs of crimping-pin-holes in the ultimate lateral formations of each of the respective first and second free ends of the belt, so as to hold the first and second free ends of the belt in proximity to each other, and
b. crimping ends of the upright members of each of the crimping pins.

117. A method of printing an image onto a substrate in a printing system including a printing station and an impression station, the method comprising:
in the printing system, forming an endless belt according to the method of any one of claims 108 to 116;
ink-jet printing an image onto a surface of said endless belt;
rotating said endless belt to move said image from the printing station to the impression station; and
transferring said image from said surface of said endless belt onto the substrate.

118. A kit for installing an endless belt in a printing system, the kit comprising:
a heat-curable tape, comprising a substrate layer and a solid silicone rubber layer disposed thereon; and
an adhesive;
wherein said heat-curable tape is adapted to be applied onto first and second free ends of a flexible belt, and to be heated so as to heat-cure said solid silicone rubber layer of said tape to the first and second free ends of the flexible belt, so as to form a seam connecting the first and second free ends thereby converting the flexible belt into the endless belt, and
wherein said adhesive is adapted to fill and seal gaps between said heat-curable tape and at least a portion of the flexible belt when said heat-curable tape is cured.

119. The kit of claim 118, wherein said adhesive is adapted to be applied onto and around an exposed surface of said heat-curable tape, when said heat-curable tape is applied onto the first and second free ends of the flexible belt.

120. The kit of claim 118 or claim 119, wherein said adhesive comprises a two component adhesive, the two components adapted to be mixed prior to application thereof onto said heat-curable tape.

121. The kit of any one of claims 118 to 120, wherein, following heat-curing of said solid silicone rubber layer of said heat curable tape, the following properties are true:
said tape has a tensile strength of at least 8 MPa;
said tape has a shore A hardness of at least 45; and
a strength of said heat curable tape is directly proportional to a heat quantity applied to said solid silicone rubber layer during curing of said tape.

122. The kit of any one of claims 118 to 120, wherein, following heat-curing of said solid silicone rubber layer of said tape, at least one of the following is true:
said tape has a tensile strength of at least 8 MPa;
said tape has a shore A hardness of at least 45;
said tape has a shore A hardness in the range of 45 to 80;
a strength of said heat curable tape is directly proportional to a heat quantity applied to said solid silicone rubber layer during curing of said tape;
a 20 mm segment of said endless belt, including said heat-cured tape, is capable of resisting a load of at least 200N, at least 220N, or at least 250N, at room temperature; and
a 20 mm segment of said endless belt, including said heat-cured tape, is incapable of resisting a load greater than 350N, greater than 380N, or greater than 400N, at room temperature.

123. The kit of any one of claims 118 to 122, wherein said solid silicone rubber has a shelf life of at least one month, at least six months, at least one year.

124. The kit of any one of claims 118 to 123, wherein a pot life of said heat curable tape is at least one of:
equal to a shelf life of said solid silicone rubber; and
at least one month, at least six months, or at least one year.

125. The kit of any one of claims 118 to 124, wherein said solid silicone rubber comprises a thermosetting polymer.

126. The kit of any one of claims 118 to 125, wherein said solid silicone rubber has a density in the range of 1.1 to 1.2 g/cm\hat{ }3, or a density of 1.15 g/cm\hat{ }3.

127. The kit of any one of claims 118 to 126, wherein said substrate layer includes a fiberglass layer.

128. The kit of claim 127, wherein said substrate layer further includes a silicone coating layer, connected to said fiberglass layer.

129. The kit of claim 128, wherein said silicone coating layer has a shore A hardness in the range of 75 to 80.

130. The kit of any one of claims 118 to 129, wherein said substrate layer has a thickness in the range of 110 μm to 170 μm.

131. The kit of any one of claims 118 to 130, wherein said solid silicone rubber layer has a thickness in the range of 20 mm to 120 μm.

132. The kit of any one of claims 118 to 131, wherein a ratio between a thickness of said solid silicone rubber layer and a thickness of said substrate layer is in the range of 0.10 to 0.75.

133. The kit of any one of claims 118 to 132, wherein said curable tape has a thickness in the range of 180 μm to 270 μm.

134. The kit of any one of claims 118 to 133, further comprising said flexible belt having said first and second free ends, said flexible belt configured to be guided along the printing system.

135. The kit of claim 134, wherein said flexible belt has at least one of the following properties:
a length within a range of 1 to 20 meters, 5 to 20 meters, 5 to 15 meters, 5 to 12 meters, or 7 to 12 meters;
a width within a range of 0.1 to 2.0 meters, 0.3 to 2.0 meters, 0.5 to 2.0 meters, 0.75 to 2.0 meters, 0.75 to 1.5 meters, or 0.75-1.25 meters; and
a thickness within a range of 50 to 3000 μm, 100 to 3000 μm, 200 to 3000 μm, 200 to 1500 μm, 300 to 1000 μm, 300 to 800 μm, 300 to 700 μm, or 100 to 600 μm.

136. The kit of any one of claims 134 to 135, wherein a ratio between a thickness of said tape and a thickness of said belt is in the range of 0.15 to 11.15.

137. The kit of any one of claims 134 to 136, wherein a length of said heat curable tape is greater than a width of said flexible belt.

138. The kit of any one of claims 134 to 137, wherein a ratio between a width of said tape and a length of said belt is in the range of 0.01 to 0.03.

139. The kit of any one of claims 134 to 138, further comprising a heater adapted to be disposed beneath said heat curable tape when said heat curable tape is applied to said first and second ends of said flexible belt, and adapted to provide heat sufficient for heat-curing said solid silicone rubber of said heat-curable tape thereby to heat-cure said heat curable tape to form said endless belt.

140. The kit of claim 139, wherein said heater includes a heating surface having a width greater than a width of said heat-cured tape.

141. The kit of claim 140, wherein the heater is designed such that a greater heat density is provided at ends of said heating surface than at a center of said heating surface.

142. The kit of claim 140, wherein the heater includes a plurality of heating elements, said heating elements being unevenly distributed across said heating surface, such that a greater heat density is provided at ends of said heating surface than at a center of said heating surface.

143. The kit of any one of claims 139 to 142, wherein said heater is adapted, during operation thereof, to provide a first operative temperature at said center of said heating surface, and to provide a second operative temperature at said ends of said heating surface.

144. The kit of any one of claims 139 to 143, wherein said heater is adapted, during operation thereof when said first and second ends of said flexible elongate belt are disposed over said heating surface, and said heat-curable tape is disposed over said first and second ends, to provide a uniform temperature across said heat-curable tape.

145. The kit of any one of claims 143 to 144, wherein, during operation of said heater, when said first and second ends of said flexible elongate belt are disposed over said heating surface, and said heat-curable tape is disposed over said first and second ends, said heater is adapted to provide said first and said second operative temperatures for a duration of at most 1 minute, at most 3 minutes, at most 5 minutes, at most 10 minutes, at most 15 minutes, or at most 20 minutes, thereby to heat-cure said solid silicone rubber of said heat-curable tape.

146. The kit of any one of claims 143 to 145, wherein said heater is adapted to reach said first and second operative temperatures within a duration of at most 1 minute, at most 3 minutes, at most 5 minutes, or at most 10 minutes.

147. The kit of any one of claims 139 to 146, wherein said flexible elongate belt has a positioning arrangement removably attached to said first and second ends, said positioning arrangement adapted for positioning said first and second ends of said belt over said heating surface of said heater during heat-curing of said heat-curable tape.

148. The kit of claim 147, wherein said positioning arrangement includes at least one magnetic element, and said heater includes at least one corresponding magnetic element adapted to magnetically attract said at least one magnetic element of said positioning arrangement during said heat-curing of said heat-curable tape.

149. The kit of claim 148, wherein said at least one magnetic element comprises a magnetic metal strip removably attached to each of said first and second ends of said flexible elongate belt.

150. The kit of any one of claims 134 to 149, wherein said flexible belt includes a rebate at each of said first and second ends, wherein when said rebates are positioned adjacent one another a channel is formed, said channel sized and adapted to accommodate said heat curable tape therein.

151. The kit of claim 150, wherein each said rebate has a depth in the range of 140 μm to 250 μm.

152. The kit of any one of claims 134 to 151, wherein:
(i) the flexible belt includes a plurality of lateral formations along at least a portion of each lateral edge, and
(ii) at least one of the lateral formations on each lateral edge at each one of the free ends of the flexible belt includes an anchoring structure adapted for attachment to an attachment mechanism, which attachment mechanism is adapted for attaching ones of said laterally extending formations at opposing free ends of each lateral edge of the flexible belt.

153. The kit of claim 152, additionally including at least two attachment mechanisms each adapted to engage at least two said anchoring structures at opposing free ends of each lateral edge of said belt and to attach the laterally extending formations associated with said anchoring structures engaged by said attachment mechanism thereby to attach said opposing free ends of each lateral edge of the flexible belt.

154. The kit of claim 153, wherein each said anchoring structure comprises a crimping-pin-hole extending through a corresponding said lateral formation in a direction orthogonal to a surface of the belt and each said attachment mechanism comprises a crimping pin having a diameter less than or equal to the diameter of a said crimping-pin hole, and adapted to simultaneously engage two said crimping-pin-holes, one in each of said opposing free ends of one of the lateral edges of the belt.

155. A kit for installing an endless belt in a printing system, the kit comprising:
a flexible belt having first and second free ends configured to be guided along the printing system, the flexible belt includes a plurality of lateral formations along at least a portion of each lateral edge thereof,
wherein at least one of the lateral formations on each lateral edge at each one of the free ends of the flexible belt includes an anchoring structure adapted for attachment to an attachment mechanism, and
at least two attachment mechanisms each adapted to engage at least two said anchoring structures at opposing free ends of each lateral edge of said belt and to attach the laterally extending formations associated with said anchoring structures engaged by said attachment mechanism thereby to attach said opposing free ends of each lateral edge of the flexible belt.

156. The kit of claim 155, wherein:
each said anchoring structure comprises a crimping-pin-hole extending through a corresponding said lateral formation in a direction orthogonal to a surface of the belt; and
each said attachment mechanism comprises a crimping pin having a diameter less than or equal to the diameter of a said crimping-pin hole, and adapted to simultaneously engage two said crimping-pin-holes, one in each of said opposing free ends of one of the lateral edges of the belt.

157. The kit of claim 155 or claim 156, wherein said flexible belt has at least one of the following properties:
a length within a range of 1 to 20 meters, 5 to 20 meters, 5 to 15 meters, 5 to 12 meters, or 7 to 12 meters;
a width within a range of 0.1 to 2.0 meters, 0.3 to 2.0 meters, 0.5 to 2.0 meters, 0.75 to 2.0 meters, 0.75 to 1.5 meters, or 0.75-1.25 meters; and
a thickness within a range of 50 to 3000 μm, 100 to 3000 μm, 200 to 3000 μm, 200 to 1500 μm, 300 to 1000 μm, 300 to 800 μm, 300 to 700 μm, or 100 to 600 μm.
